(19) United States
(12) Patent Application Publication
(10) Pub. No.: US 2026/0086194 A1
(43) Pub. Date: Mar. 26, 2026

(54) Reconfigurable Multimode Radar

(71) Applicant: Qualcomm Incorporated, San Diego, CA (US)

(72) Inventors: Roberto Rimini, San Diego, CA (US); Chinmaya Mishra, San Diego, CA (US); Sheng-Yuan Tu, San Diego, CA (US)

(21) Appl. No.: 18/895,050

(22) Filed: Sep. 24, 2024

(51) Int. Cl. G01S 7/282; G01S 7/04; G01S 7/40; G01S 13/36; G06F 3/01

(52) U.S. Cl. CPC G01S 7/282; G01S 7/043; G01S 7/4013; G01S 13/36; G06F 3/017

(57) ABSTRACT

An apparatus is disclosed for reconfiguring a multimode radar. In example implementations, the apparatus includes a wireless transceiver for a mobile device that is configured to be connected to one or more antennas. The wireless transceiver is configured to determine one or more radar signal parameter settings based on at least one environmental factor. The wireless transceiver is also configured to transmit a radar transmit signal using the one or more radar signal parameter settings. The wireless transceiver is additionally configured to receive a radar receive signal that results from a reflection of the radar transmit signal. The wireless transceiver is further configured to sense an object using the radar receive signal.

### TECHNICAL FIELD

This disclosure relates generally to wireless transceivers and, more specifically, to reconfiguring a multimode radar for multipurpose object sensing.

### BACKGROUND

Electronic devices include traditional computing devices such as desktop computers, notebook computers, smartphones, wearable devices like a smartwatch, internet servers, and so forth. Electronic devices also include other types of computing devices such as personal voice assistants (e.g., smart speakers), wireless access points or routers, thermostats and other automated controllers, robotics, automotive electronics, devices embedded in other machines like refrigerators and industrial tools, Internet of Things (IoT) devices, medical devices, and so forth. These various electronic devices provide services relating to productivity, communication, social interaction, security, health and safety, remote management, entertainment, transportation, and information dissemination. Thus, electronic devices play crucial roles in modern society.

Many of the services provided by electronic devices in today's interconnected world depend at least partly on electronic communications. Electronic communications can include, for example, those exchanged between two or more electronic devices using wireless or wired signals that are transmitted over one or more networks, such as the Internet, a Wi-Fi® network, or a cellular network. Electronic communications can therefore include wireless or wired transmissions and receptions. To transmit and receive communications, an electronic device can use a transceiver, such as a wireless transceiver that is designed for wireless communications.

Electronic communications can therefore be realized by propagating signals between two wireless transceivers at two different electronic devices. For example, using a wireless transmitter, a smartphone can transmit a wireless signal to a base station over the air as part of an uplink communication to support mobile services. Using a wireless receiver, the smartphone can receive a wireless signal that is transmitted from the base station via the air medium as part of a downlink communication to enable mobile services. With a smartphone, mobile services can include making voice and video calls, participating in social media interactions, sending messages, watching movies, sharing videos, and performing searches. Other mobile services can include using map information or navigational instructions, finding friends, engaging in location-based services generally, transferring money, obtaining another service like a car ride, and so forth.

With the variety and ubiquity of mobile services, users tend to keep their mobile devices with them most of the time. Consequently, researchers, electrical engineers, and designers of electronic devices are striving to develop other beneficial uses for mobile devices.

### SUMMARY

Users carry mobile devices, such as smart phones, into different environments and use them for various purposes. Some of these environments and purposes may be associated with physical objects that are proximate to a mobile device. Accordingly, there is growing interest in the wireless communication industry to add capabilities to mobile devices to sense physical objects. This document describes apparatuses and techniques to enable an electronic device (e.g., a computing device) to sense objects in power efficient manners, in response to user input indicative of a current radar application, based on environmental conditions, using hardware that can also be used for communication, and so forth.

In example implementations, a wireless transceiver includes a radar system that can transmit radar transmit signals and receive radar receive signals, with at least one radar receive signal resulting from a reflection of a radar transmit signal. The radar system can discern one or more attributes about an object that caused the reflection. Examples of such attributes include presence, range, size, speed, direction, motion, and the like. A radar system can detect a vehicle, a person, a hand or arm that is gesturing, and so forth in accordance with different user applications or other circumstances.

The radar system can determine multiple radar signal parameter settings based on one or more environmental factors. Environmental factors can include ambient conditions, contemporaneous activities, user input indicative of a current radar application, and so forth. For instance, the user may be empowered to explicitly establish a radar-related application. To do so, an electronic device can present a user interface that provides multiple user-selectable application options, such as vehicular sensing for a bike ride, people sensing for security, hand sensing for gesture detection, and so forth.

A processor of a wireless transceiver (e.g., a modem) can apply the one or more environmental factors to a multi-dimensional matrix to determine the multiple radar signal parameter settings. Radar signal parameters can include signal-related characteristics (e.g., frequency) and radar-related characteristics (e.g., pulse repetition interval). Settings for multiple radar signal parameters can be determined to increase power efficiency, to moderate required processing resources, and so forth. In one example, transmit power is reduced responsive to a targeted object being within a near range, but transmit power is increased for a far-range targeted object. In another example, as the range to a targeted object increases, the radar bandwidth is decreased to modulate a sampling frequency and reduce a quantity of samples to store and process. Thus, these techniques can increase power and processing efficiencies.

In example implementations, a wireless transceiver can support radar signaling for object sensing and wireless communication signaling by including a radar signaling path and a shared signaling path, which paths may support different frequency bands. This allows some hardware to be reused for different signaling purposes. To facilitate hardware reuse, signal couplings between the two signaling paths can be strategically realized to bypass certain components, or the signal couplings can be carefully avoided to lower undesired mutual coupling between transmit and receive radar signals. These various implementations may be used separately or in any combination for a reconfigurable multimode radar. These and other example implementations are described herein.

In an example aspect, an apparatus for a reconfigurable multimode radar is disclosed. The apparatus includes a wireless transceiver for a mobile device. The wireless transceiver is configured to be connected to one or more antennas. The wireless transceiver is configured to determine one or more radar signal parameter settings based on at least one environmental factor and transmit a radar transmit signal using the one or more radar signal parameter settings. The wireless transceiver is also configured to receive a radar receive signal that results from a reflection of the radar transmit signal and sense an object using the radar receive signal.

In an example aspect, an apparatus for reconfiguring a multimode radar for multipurpose object sensing is disclosed. The apparatus includes means for determining one or more radar signal parameter settings based on at least one environmental factor and means for transmitting a radar transmit signal using the one or more radar signal parameter settings. The apparatus also includes means for receiving a radar receive signal that results from a reflection of the radar transmit signal and means for sensing an object using the radar receive signal.

In an example aspect, a method for reconfiguring a multimode radar for multipurpose object sensing is disclosed. The method includes determining, based on at least one environmental factor, one or more radar signal parameter settings for a wireless transceiver of a mobile device. The method also includes transmitting a radar transmit signal using the one or more radar signal parameter settings. The method additionally includes receiving a radar receive signal that results from a reflection of the radar transmit signal. The method further includes sensing an object using the radar receive signal.

### BRIEF DESCRIPTION OF DRAWINGS

FIG. 1 illustrates an example operating environment for a reconfigurable multimode radar as described herein.

FIG. 2 illustrates an example operating environment for performing object sensing with a reconfigurable multimode radar in conjunction with wireless communication as described herein.

FIG. 3 illustrates an example sensing of one or more attributes of an object using a reconfigurable multimode radar as described herein.

FIG. 4-1 illustrates an example scheme for reconfiguring the radar signal parameter settings of a multimode radar based on at least one environmental factor as described herein.

FIG. 4-2 illustrates example radar signal parameters that can be reconfigured for multipurpose object sensing.

FIG. 4-3 is a flow diagram illustrating an example process for sensing objects using radar signal parameter settings that are reconfigured based on at least one environmental factor.

FIG. 5 illustrates examples of a wireless transceiver, an object sensing unit, radio signal parameter setting logic, and a modem that can perform multimode radar reconfiguring as described herein.

FIG. 6 illustrates an example frequency signal generator having an oscillator circuit for supporting wireless communication in conjunction with object sensing using a reconfigurable multimode radar.

FIG. 7 illustrates a spatial relationship between FIGS. 7-1 and 7-2.

FIG. 7-1 illustrates an example multi-dimensional matrix of radar signal parameter settings that is linked to multiple example radar applications.

FIG. 7-2 illustrates an example user interface that is generated by a computing device and that enables a user to select a radar application from multiple example radar applications for sensing objects.

FIG. 8 is a graph illustrating an example approach to maintaining a beat frequency range across multiple radar applications that correspond to multiple distance ranges.

FIG. 9 illustrates an example wireless transceiver that includes an example radar signaling path for radar operations and an example shared signaling path for radar operations and wireless communications.

FIG. 10 illustrates example radar signal parameter settings that can be reconfigured for different radar applications across at least one dwell time.

FIG. 11 is a flow diagram illustrating an example process for sensing objects using radar signal parameter settings that are configured based on at least one environmental factor.

### DETAILED DESCRIPTION

To increase transmission rates and throughput, cellular and other wireless networks are using signals with higher frequencies and smaller wavelengths. As an example, 5th or 6th generation (5G or 6G)-capable devices communicate with networks using frequencies that include those at or near the extremely high frequency (EHF) spectrum (e.g., frequencies greater than 25 gigahertz (GHz)) with wavelengths at or near millimeter wavelengths. These signals are associated with various technological challenges, such as higher path loss as compared to signals for earlier generations of wireless communications at relatively lower frequencies. These higher frequencies can, however, be used for other purposes, such as radar-related ones. One portion of the EM spectrum that has higher frequencies and may be used often is a part of the 5G licensed band, such as the 24.25 GHz to 28.25 GHz frequency range. Such frequencies, as well as other frequencies (e.g., 60 GHz), can be used for radar signaling in addition to signaling for wireless communication.

As noted above, users tend to keep their mobile devices with them throughout most of their daily activities, and they often have these devices within arm's reach. Accordingly, researchers, electrical engineers, and other designers of electronic devices strive to develop additional beneficial uses for mobile devices, one of which is object sensing. Some object-sensing techniques may use a dedicated sensor, such as a camera or an infrared sensor, to detect an object. But these sensors may be bulky or expensive. Furthermore, an object may be located at any position or along any axis relative to an electronic device (e.g., on top, on bottom, in back, in front, or at a side of a device). To account for each of these positional possibilities, multiple cameras or sensors may need to be installed to monitor each direction or potential position, which further increases the cost and size of the electronic device.

Instead, certain devices and techniques for object sensing that are described herein can utilize a wireless transceiver and one or more antennas within a computing device to transmit and receive radar signals and determine one or more aspects of an object. These aspects can include, for example, the range, direction, speed, size, or shape of an object, including any combination thereof using a permitted (but optional) inclusive-or interpretation of the word “or.” Radar technology can therefore be used to sense objects and achieve one or more purposes. Examples of radar-related purposes include sensing objects at various distance ranges, mapping an environment, providing other forms of radio frequency (RF) or mmW sensing, implementing sensor-assisted communication, implementing joint-device communicating and sensing, detecting gestures being used to control or communicate with a device, and so forth.

In example operations for using radar for object sensing, a device can transmit a radar transmit signal and receive a corresponding radar receive signal. The radar receive signal may include a reflection signal component that is created by an object that is impacted by the radar transmit signal. To perform object sensing, the device can identify the reflected signal component and determine one or more attributes of an object, such as presence, distance, speed, direction, movement, contour or shape, and so forth.

Accordingly, an electronic device (e.g., a computing device) can employ object sensing to detect attributes of nearby objects with a radar transmit signal and a radar receive signal using hardware such as antennas, transmitters, receivers, mixers, frequency generators, and so forth. A multimode radar can generate and use radar signals having different parameters, which are described herein. The multimode radar can reconfigure the different parameters based on at least one environmental factor, which are also described herein. If a radar transmit signal reflects from a proximate object, the radar receive signal can include a reflection signal component. Responsive to detection of the reflection signal component, in addition to determining the presence of an object, the computing device can determine a range to an object, a speed of an object, movement of an object, and so forth.

In some implementations that are described herein, at least part of transceiver hardware that is usable to perform object sensing may be shared with (e.g., repurposed or extended for use with) wireless communication for a user of a computing device. Thus, some hardware may be shared between at least two functionalities to increase efficiency or reduce circuitry within a computing device. In other implementations, however, object sensing hardware (e.g., a reconfigurable radar system) may be dedicated to object sensing functionality or may be at least separate from hardware supporting wireless communication, in situations in which hardware for both of such functionalities is present in a given device. Further, object sensing hardware may alternatively be part of a device dedicated to sensing objects that omits hardware for wireless communication.

In example implementations, a wireless transceiver includes a radar system that can transmit radar transmit signals and receive radar receive signals, with at least one radar receive signal resulting from a reflection of a radar transmit signal. The radar system can discern one or more attributes about an object that caused the reflection. Examples of such attributes include presence, range, speed, direction, motion, size, and shape. A radar system can detect a vehicle, a person, a hand or arm that is gesturing, and so forth in accordance with different user applications or other circumstances.

The radar system can determine multiple radar signal parameter settings based on one or more environmental factors. Environmental factors can include ambient conditions, current activities, user input, and so forth. In some cases, a processor of a wireless transceiver (e.g., a modem) can apply one or more ascertained environmental factors to a multi-dimensional matrix to determine the multiple radar signal parameter settings. In other examples, a neural processor or other processor can evaluate a set of inputs to determine the multiple radar signal parameter settings using an artificial intelligence model. Radar signal parameters can include signal-related characteristics, such as frequency range (e.g., frequency band), frequency bandwidth, transmit power, and so forth. Additionally or alternatively, radar signal parameters can include radar-related characteristics, such as a width of a chirp, a dwell time, a number of chirps per dwell time, a pulse repetition interval (PRI) for consecutive chirps, a length of a frame period before a dwell time repeats, and so forth.

Settings for multiple radar parameters can be determined to increase power efficiency, moderate required processing resources, and so forth. In one example, transmit power is reduced responsive to a targeted object being within a near range, while transmit power is increased for a far-range targeted object. This approach can decrease power usage. In another example, as the range to a targeted object increases, the radar bandwidth is reduced. This enables a near-range object to be sensed with a relatively wider radar bandwidth to achieve a higher resolution, which may be beneficial for gesture detection, for instance. Far-range objects, such as vehicles, can still be sensed with lower resolution from a lower-bandwidth radar signal. By changing the bandwidth inversely with object range, a common beat frequency, or at least a common beat-frequency range, can be achieved. This common beat-frequency range can modulate how many digital samples are taken to sense objects, which can reduce hardware requirements in terms of processing capability or memory size, in addition to reducing the power for computations.

In example implementations, the user is empowered to explicitly establish a radar-related application. For example, an electronic device can present (e.g., display) a user interface that provides multiple application options that are selectable by a user. Such applications can include, for example, vehicular sensing for a bike ride, people sensing for security, hand sensing for gesture detection, and so forth. Responsive to the selected application, the radar system can determine radar signal parameter settings based on increasing power efficiency, modulating processing demands, and so forth in accordance with likely range, speed, or other characteristics of a targeted object.

In example implementations, a wireless transceiver can support radar signaling for object sensing and wireless communication signaling by including multiple signaling paths, such as a radar signaling path and a shared signaling path. Each signaling path can correspond to a different frequency range. The shared signaling path permits radar signal transceiving and wireless-communication signal transceiving. In one approach, a frequency synthesizer can be used to transceive radar signals using the radar signaling path and the shared signaling path with different frequency bands. In another approach, the shared signaling path includes multiple antenna ports for coupling to an antenna array. Mutual coupling may be reduced by selecting appropriate antenna elements of the antenna array for transmitting a radar transmit signal and for receiving a radar receive signal. These different approaches may be used together in any combination.

Further, these various implementations may be used separately or in any combination for a reconfigurable multimode radar. For instance, the multi-signaling-path wireless transceiver can be used to emanate radar signals and collect reflected radar signals using radar signal parameter settings that are determined based on at least one environmental factor. Additionally or alternatively, enabling a user to indicate a selected object-sensing application can be employed with the ascertainment of other environmental factors. Using one or more of these different techniques, objects can be sensed in power and processing efficient manners in accordance with different radar-related applications. These and other example implementations are described herein.

Generally, some implementations may offer a relatively inexpensive approach that can utilize existing transceiver hardware and antennas. An object sensing unit may marginally impact a design of a wireless transceiver and can be implemented at least partly in software or hardware, which may be at least partially shared with components for wireless communication (or user proximity detection), or vice versa. Nonetheless, object sensing using a reconfigurable radar system as described herein can be implemented outside of or separate from hardware that supports wireless communication (or user proximity detection) capabilities.

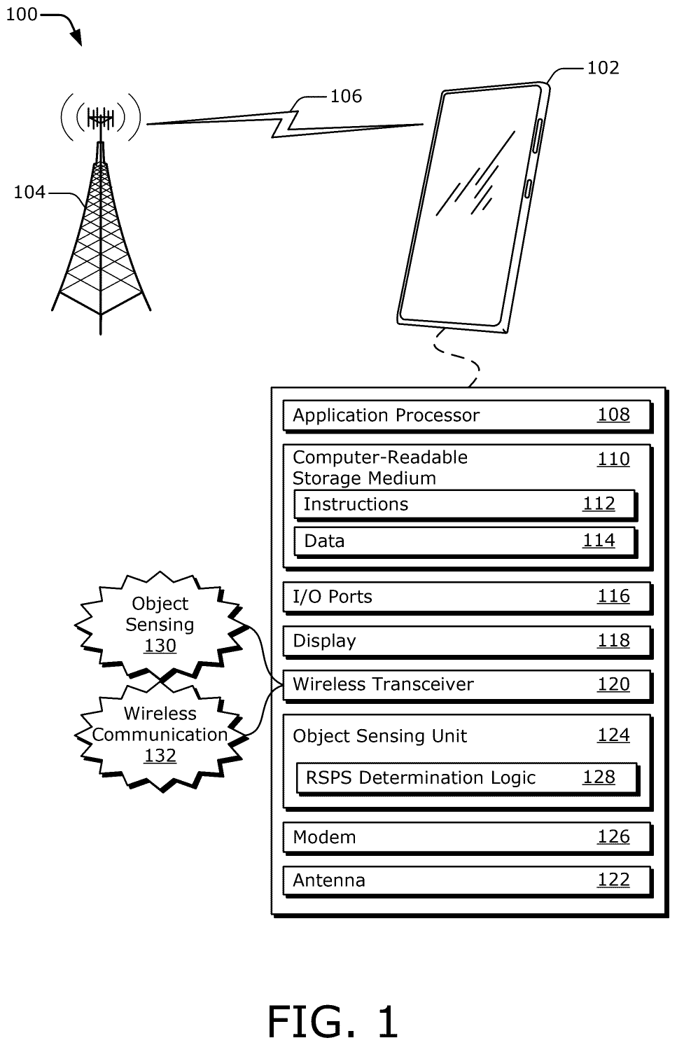

FIG. 1 illustrates an example operating environment 100 for a reconfigurable multimode radar as described herein. In the environment 100, an example computing device 102 (or, more generally, example electronic device 102) communicates with a base station 104 through a wireless communication link 106 (wireless link 106). In this example, the computing device 102 is depicted as a smartphone. However, the computing device 102 can be implemented as any suitable computing or electronic device, such as a modem, a cellular base station, a broadband router, an access point, a cellular phone, customer premises equipment (CPE), a gaming device, a navigation device, a media device, a laptop computer, a desktop computer, a tablet computer, a wearable computer, a server, a network-attached storage (NAS) device, a smart appliance or other internet of things (IoT) device, a medical device, a vehicle-based communication system, a radar, a radio apparatus, a proximity detection apparatus for a drone or passenger vehicle, and so forth.

The base station 104 communicates with the computing device 102 via the wireless link 106, which can be implemented as any suitable type of wireless link. Although depicted as a tower of a cellular network, the base station 104 can represent or be implemented as another device, such as a satellite, a server device, a terrestrial television broadcast tower, an access point, a peer-to-peer device, another smartphone, a mesh network node, and so forth. Therefore, the computing device 102 may communicate with the base station 104 or another device via a wireless connection.

The wireless link 106 can include a downlink of data or control information communicated from the base station 104 to the computing device 102, an uplink of other data or control information communicated from the computing device 102 to the base station 104, or both a downlink and an uplink. The wireless link 106 can be implemented using any suitable communication protocol or standard, such as 2nd-generation (2G), 3rd-generation (3G), 4th-generation (4G), 5th-generation (5G), or 6th-generation (6G) cellular; IEEE 802.11 (e.g., Wi-Fi®); IEEE 802.15 (e.g., Bluetooth® or UWB); IEEE 802.16 (e.g., WiMAX®); and so forth. In some implementations, the wireless link 106 may wirelessly provide power, and the base station 104 or the computing device 102 may comprise a power source.

As shown, the computing device 102 includes an application processor 108 and a computer-readable storage medium 110 (CRM 110). The application processor 108 can include any type of processor, such as a multi-core processor or a system-on-chip (SoC), that executes processor-executable code stored by the CRM 110. The CRM 110 can include any suitable type of data storage media, such as volatile memory (e.g., random access memory (RAM)), nonvolatile memory (e.g., Flash memory), optical media, magnetic media (e.g., disk), and so forth. In the context of this disclosure, the CRM 110 is implemented to store instructions 112, data 114, and other information of the computing device 102, and thus the CRM 110 does not include transitory propagating signals or carrier waves.

The computing device 102 can also include input/output ports 116 (I/O ports 116) and a display 118. The I/O ports 116 enable data exchanges or interaction with other devices, networks, or users. The I/O ports 116 can include serial ports (e.g., universal serial bus (USB) ports), parallel ports, Ethernet ports, audio ports, infrared (IR) ports, user interface ports such as a sensing portion of a touchscreen or a camera, and so forth. The display 118 (e.g., a display screen or a projected display image) presents graphics of the computing device 102, such as a user interface associated with an operating system, program, or application. Alternatively or additionally, the display 118 can be implemented as a display port or virtual interface, through which graphical content of the computing device 102 is presented, and/or the display 118 can be omitted. Although not shown, a computing device 102 can include one or more other sensors to obtain information about at least one environmental factor. Examples of sensors include, but are not limited to, a camera sensor, an image or light sensor, an infrared (IR) sensor, a magnetometer, a humidity sensor, an anemometer, an accelerometer, a thermometer for ambient temperature sensing or remote object temperature sensing, a gyroscope, an inertial measurement unit (IMU), a pressure sensor, a heartrate sensor, a breath rate sensor, a barometer, a positional sensor (e.g., a global positioning system (GPS) or other satellite positioning system (SPS) chip (aka, a global navigation satellite system (GNSS) chip)), a touch sensor (which may be integrated with a display screen), a physical or virtual button, a microphone, combinations or composites thereof, and so forth.

A wireless transceiver 120 of the computing device 102 provides connectivity to respective networks and other electronic devices connected therewith. The wireless transceiver 120 can facilitate communication over any suitable type of wireless network, such as a wireless local area network (WLAN), peer-to-peer (P2P) network, mesh network, cellular network, ultra-wideband (UWB) network, wireless wide-area-network (WWAN), and/or wireless personal-area-network (WPAN). In the context of the example environment 100, the wireless transceiver 120 enables the computing device 102 to communicate with the base station 104 and networks connected therewith. However, the wireless transceiver 120 can also enable the computing device 102 to communicate “directly”with other devices or networks.

The wireless transceiver 120 includes circuitry and logic for transmitting and receiving signals via an antenna 122. Components of the wireless transceiver 120 can include amplifiers, switches, mixers, analog-to-digital converters (ADCs), digital-to-analog converters (DACs), filters, and so forth for conditioning signals (e.g., for generating or processing signals). The wireless transceiver 120 can also include logic to perform in-phase/quadrature (I/Q) operations, such as synthesis, encoding, modulation, decoding, demodulation, and so forth. In some cases, components of the wireless transceiver 120 are implemented as separate transmitter and receiver entities. Additionally or alternatively, the wireless transceiver 120 can be realized using multiple or different sections to implement respective transmitting and receiving operations (e.g., separate transmit and receive chains).

In general, the wireless transceiver 120 processes data and/or signals transceived via the antenna 122. The data and/or signals can be associated with communicating data of the computing device 102 over the antenna 122 for wireless communication 132 and/or associated with object sensing 130. In some implementations, the antenna 122 is implemented as at least one antenna array that includes multiple antenna elements. Thus, as used herein, an “antenna” can refer to at least one discrete or independent antenna, to at least one antenna array that includes multiple antenna elements, or to a portion of an antenna array (e.g., an antenna element), depending on context or implementation.

In the example shown in FIG. 1, the computing device 102 includes at least one object sensing unit 124 and at least one modem 126. The object sensing unit 124 can be or can be part of a separate module, or the object sensing unit 124 can be integrated within the wireless transceiver 120 and/or the modem 126. Further, the object sensing unit 124 may be part of a single module or may be distributed across two or more modules or other components of the computing device 102. In general, the object sensing unit 124 can be incorporated in or realized using software, firmware, hardware, fixed logic circuitry, or combinations thereof. The object sensing unit 124 can be fully or partially implemented within an integrated circuit or as part of the modem 126 or other electronic component of the computing device 102, such as the application processor 108 or another processor (e.g., an artificial intelligence (AI) accelerator). In some implementations, the modem 126 may execute computer-executable instructions that are stored within the illustrated CRM 110 or another CRM to realize the object sensing unit 124 or to implement one or more of the techniques performed by the object sensing unit 124. The object sensing unit 124 may include one or more sensors or may utilize other sensors of the computing device 102 as described herein.

In example implementations, the object sensing unit 124 can perform object sensing 130, such as by sensing one or more attributes of an object. To do this, the object sensing unit 124 can transmit a radar transmit signal and receive a radar receive signal using the wireless transceiver 120. The object sensing unit 124 can tailor the radar transmit signal responsive to at least one environmental factor, as is described herein. The tailoring of the radar transmit signal can save transmission power. Further by appropriate tailoring of the radar transmit signal, processing power that is used to analyze the radar receive signal to identify a reflected signal component can also be saved. The object sensing unit 124 can use the reflected signal component to determine attributes such as range, speed, and movement of a targeted object.

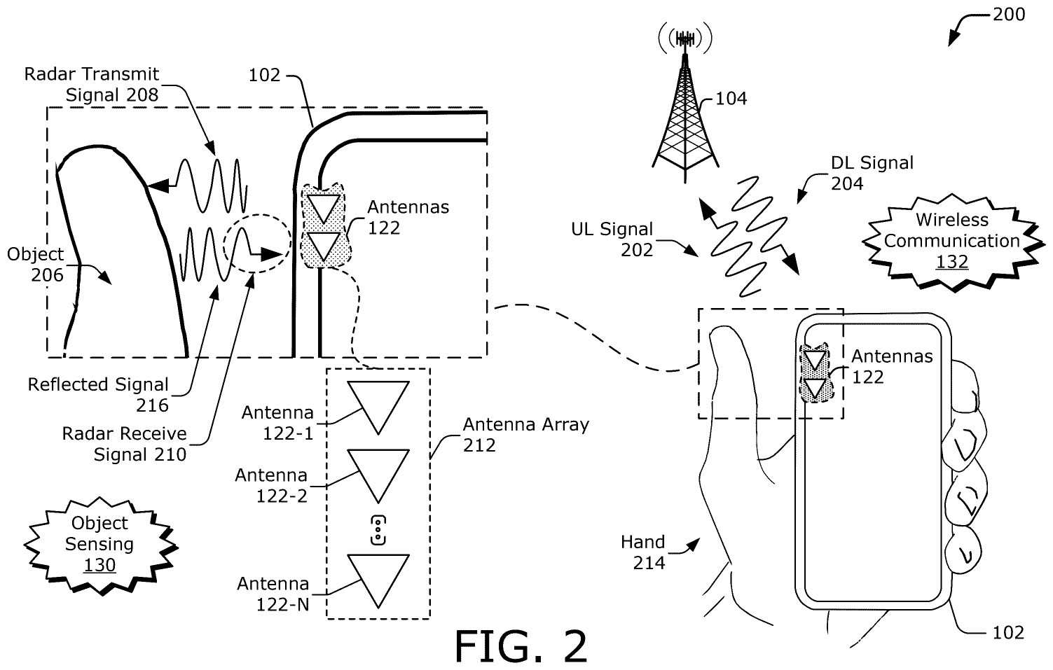

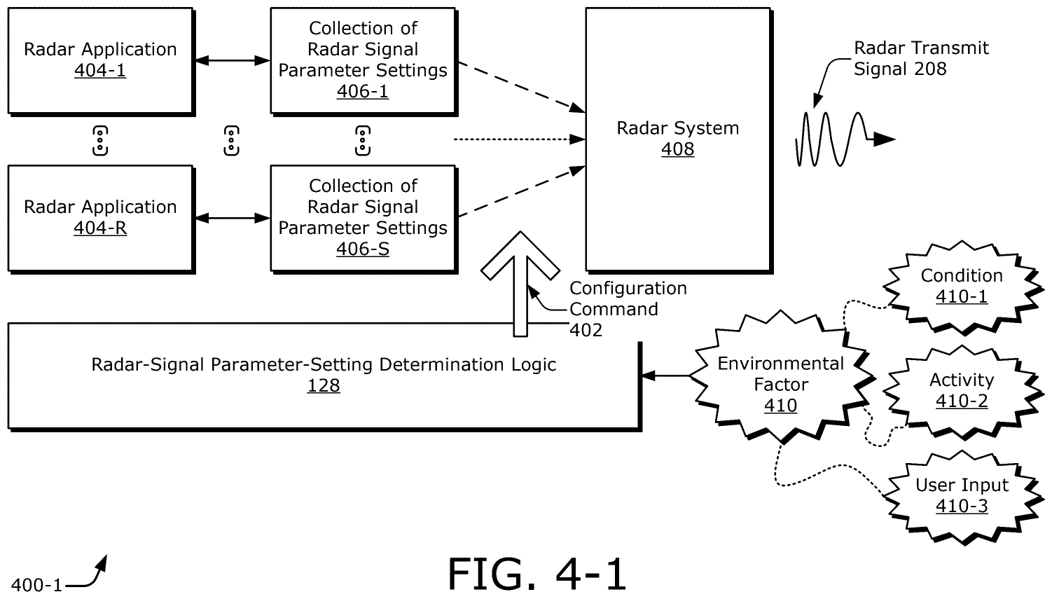

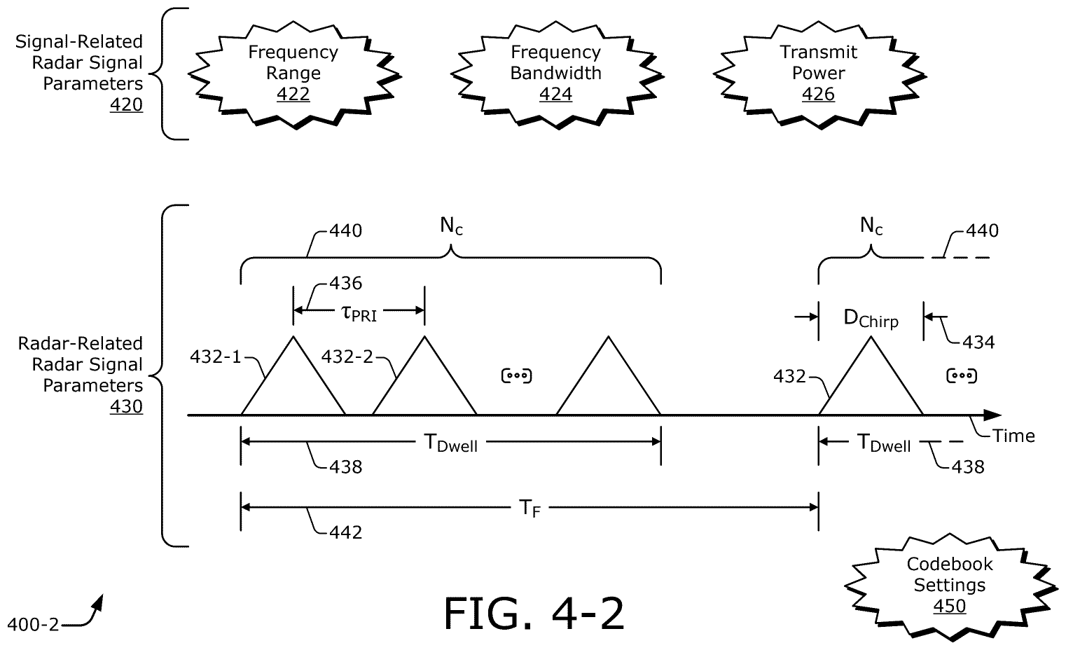

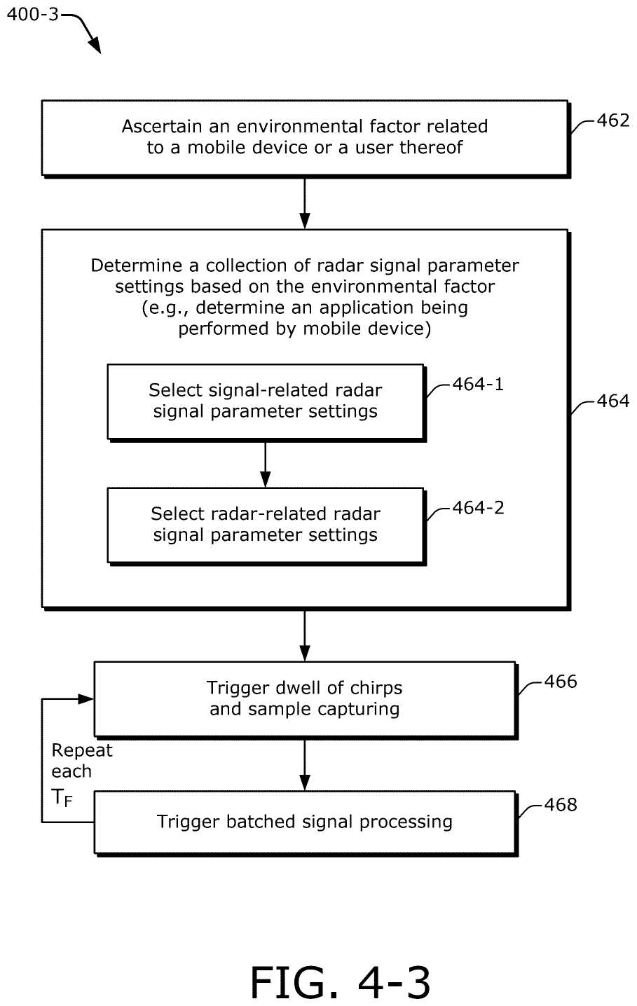

In other example implementations, the object sensing unit 124 includes at least one instance of radar-signal parameter-setting determination logic 128 (RSPS determination logic 128). The radar-signal parameter-setting determination logic 128 can determine a radar signal parameter setting (RSPS) based on at least one environmental factor. Examples of environmental factors are described below with reference to FIG. 4-1. Examples of radar signal parameter settings are described below with reference to FIG. 4-2.

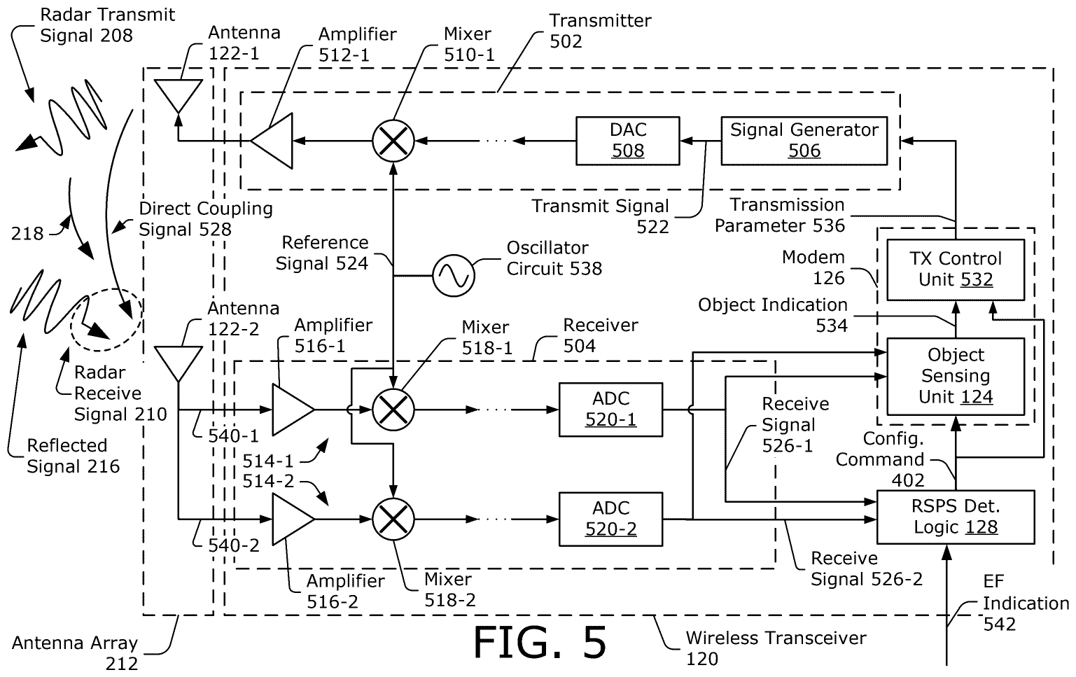

The modem 126 may be separate from the wireless transceiver 120 or be a part thereof (e.g., as explicitly depicted in FIG. 5 but not FIG. 1). The modem 126, which can be implemented as at least one processor, controls the wireless transceiver 120 and enables object sensing 130 and/or wireless communication 132 to be performed. The modem 126 can include a portion of the CRM 110 or can access the CRM 110 to obtain computer-readable instructions. The modem 126 can include baseband circuitry to perform high rate sampling processes that can include analog-to-digital conversion, digital-to-analog conversion, Fourier transforms, gain correction, skew correction, frequency translation, and so forth. The modem 126 can provide transmission data to the wireless transceiver 120 for transmission. The modem 126 can also process a baseband version of a received signal obtained from the wireless transceiver 120 to generate reception data. The received data can be provided to other parts of the computing device 102 via a communication interface for wireless communication 132, or the received data can be used for a sensing operation in accordance with object sensing 130.

The computing device 102 can also include a controller (not separately shown), e.g., to realize the object sensing unit 124. The controller can include at least one processor and CRM, which stores computer-executable instructions (such as the application processor 108 or a general-purpose or dedicated microprocessor, the CRM 110, and the instructions 112). The processor and the CRM can be localized at one physical module or one integrated circuit chip or can be distributed across multiple physical modules or chips. Together, a processor and associated instructions can be realized in separate circuitry, fixed logic circuitry, hard-coded logic, and so forth. The controller can be implemented as part of the wireless transceiver 120, the modem 126, the application processor 108, a special-purpose processor configured to perform object-sensing techniques, a general-purpose processor, some combination thereof, and so forth.

In example implementations, the wireless transceiver 120 supports object sensing 130 and/or wireless communication 132. For instance, the wireless transceiver 120 can be configured to perform object sensing 130 during a first time interval and to perform wireless communication 132 during a second time interval. In some cases, at least a portion of the hardware used to perform object sensing 130 can be “reused” or shared to perform wireless communication 132.

In other example implementations, the wireless transceiver 120 supports object sensing 130 but does not support wireless communication 132. In these cases, the wireless transceiver 120 can be a transceiver of a dedicated radar system, which may be integrated within the computing device 102 or realized as a stand-alone radar system. In still other example implementations, the wireless transceiver 120 supports other applications, which can benefit from aspects of object sensing 130 as described herein. In additional examples, separate transceivers (or at least separate receive chains) are respectively configured for object sensing 130 and for wireless communication 132.

FIG. 2 illustrates an example operating environment 200 for performing object sensing with a reconfigurable multimode radar in conjunction with wireless communication as described herein. In the example environment 200, a hand 214 of a user holds the computing device 102. In one aspect, for wireless communication 132, the computing device 102 communicates with the base station 104 by transmitting an uplink signal 202 (UL signal 202) or receiving a downlink signal 204 (DL signal 204) via the two or more antennas 122. However, a user's thumb, for instance, can represent a proximate object 206 that may be exposed to radiation via the uplink signal 202.

Other situations are also possible in which the user represents the proximate object 206, including those in which the user is near the computing device 102 but not physically touching the computing device 102. In an example situation, the computing device 102 is positioned within arm's reach of the user on a desk. As another example situation, the computing device 102 is propped up on a table, and the user is watching a video on the computing device 102 from a distance, or the computing device 102 is being used as a hotspot. In still another example situation, the computing device 102 is realized as a customer premises equipment (CPE), such as an access point or fixed cellular device, where a user may occasionally approach the device.

To detect whether the object 206 exists or is within a detectable range, the computing device 102 transmits a radar transmit signal 208 via at least one of the antennas 122 and receives a radar receive signal 210 via at least another one of the antennas 122. In some cases, the radar receive signal 210 can be received during a portion of time that the radar transmit signal 208 is transmitted or is being transmitted. The radar transmit signal 208 can be implemented, for example, as a frequency-modulated continuous-wave (FMCW) signal or a frequency-modulated pulsed signal. The type of frequency modulation can include a linear frequency modulation, a triangular frequency modulation, a sawtooth frequency modulation, and so forth. Based on the radar receive signal 210, the presence of and/or the range to the object 206 can be determined. The same antennas 122 or a subset of the same antennas 122 used to communicate with the base station 104 can be used for radar operation, for example to determine a range to the object 206. In other examples, one or more of the antennas 122 used for radar operation are not used for communicating with the base station 104.

In FIG. 2, the radar receive signal 210 is shown to include a reflected signal 216. The reflected signal 216 is or includes a reflected signal component, such as a version or portion of the radar transmit signal 208 that is reflected by the object 206. A propagation distance between the antennas 122 and the object 206, a partial absorption of the radar transmit signal 208 via the object 206, and/or an initial transmit power of the radar transmit signal 208 may change a strength of the reflected signal 216. The reflected signal 216 may also have a different phase or frequency relative to the radar transmit signal 208 based on reflection properties or motion of the object 206. In general, the reflected signal 216, or reflected signal component, contains information that can be used for detecting the object 206, for determining a range to the object 206, or for performing some other object-sensing functionality.

The one or more antennas 122 may be arranged via arrays or modules and may have a variety of configurations. For example, the one or more antennas 122 may comprise at least two different antennas, at least two antenna elements of an antenna array 212 (as shown towards the lower center portion of FIG. 2), at least two antenna elements associated with different antenna arrays, or any combination thereof. The antenna array 212 is shown to include multiple antennas 122-1, 122-2, . . . , 122-N, where N represents a positive integer greater than one. Thus, the wireless transceiver 120 (e.g., of FIGS. 1 and 5) can be connected to multiple antennas 122-1 to 122-N.

Further, the antenna array 212 may be a multi-dimensional array. Additionally or alternatively, the array 212 may be configured for beam management techniques, such as beam determination, beam measurement, beam reporting, or beam sweeping. A distance between the antennas 122 within the antenna array 212 can be based on frequencies that the wireless transceiver 120 emits or is to receive (e.g., sense or collect over the air). For example, the antennas 122 can be spaced apart by approximately half a wavelength from one another (e.g., by approximately half a centimeter (cm) apart for frequencies around 30 GHz). The antennas 122 may be implemented using any type of antenna, including patch antennas, dipole antennas, bowtie antennas, or a combination thereof.

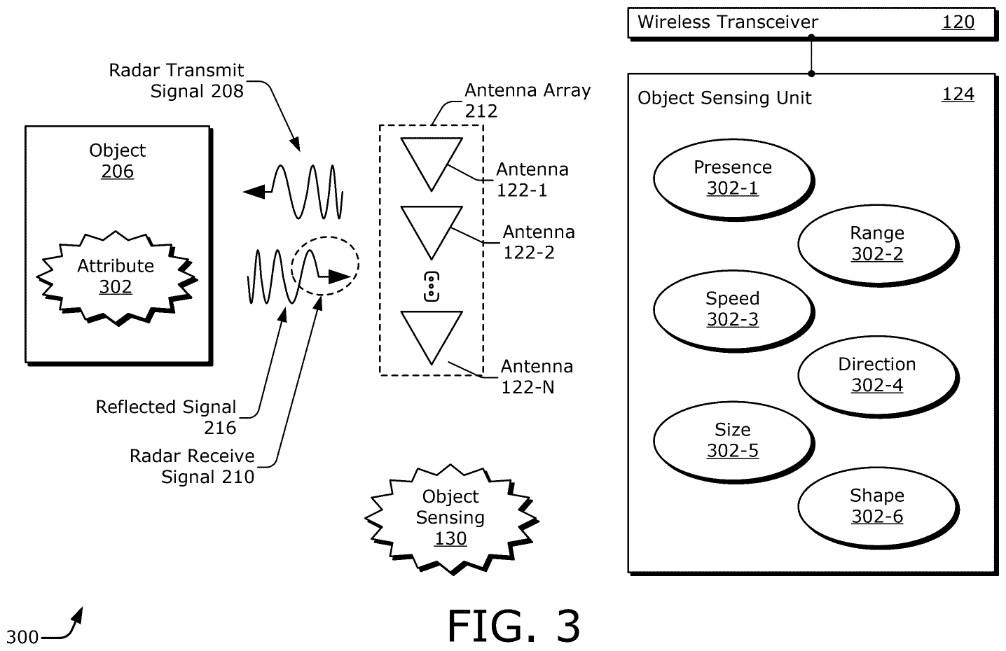

Consider, for example, the one or more antennas 122 as comprising a first antenna 122-1 and a second antenna 122-2 of the antenna array 212. In operation, for object sensing 130, the first antenna 122-1 transmits the radar transmit signal 208, and the second antenna 122-2 receives the radar receive signal 210. In operation, for wireless communication 132, any one or more of the antennas 122-1 to 122-N may transmit the UL signal 202 and/or receive the DL signal 204 in a frequency-division duplexing (FDD) or time-division duplexing (TDM) manner. Thus, an antenna 122 is one example of hardware that may be shared between object sensing 130 and wireless communication 132. With object sensing 130, an object 206 that is part of a user, such as a hand 214, can be sensed. Thus, gesture detection or appropriate monitoring and control of maximum permitted exposure (MPE) limits can be implemented, for instance. Accordingly, a computing device 102 (e.g., hardware, firmware, software, operating system (OS), basic input/output system (BIOS), or a combination thereof) can determine a distance to a person and adapt (e.g., create or alter) one or more transmission parameters to reduce the person's exposure to meet an MPE limit. Example attributes of an object 206 that can be sensed as part of object sensing 130 is described next with respect to FIG. 3.

FIG. 3 illustrates, generally at 300, an example sensing of one or more attributes 302 of an object 206 using a reconfigurable multimode radar as described herein. An object 206 that is targeted for sensing has at least one attribute 302 that can be sensed by the object sensing unit 124 using the wireless transceiver 120. Examples of attributes 302 include a presence 302-1, a range 302-2 (or distance), a speed 302-3, a direction 302-4, a size 302-5, and a shape 302-6 (or contour). The object sensing unit 124 can, however, sense more, fewer, and/or different attributes 302. For instance, the object sensing unit 124 may sense a motion (or movement) of an object 206. The motion may relate to relatively smaller scale movement that does not equate to a full translation of the object 206 through space, such as vibrations, rotations, or positional changes that do not appreciable change the location of an object's center of mass.

Sensing one or more attributes 302 of an object 206 can enable various purposes or tasks, such as alerting a user, interpreting a user's intentions, identifying an object or a risk of the object to a user, a combination thereof, and so forth. To fulfill a given purpose, the object sensing 130 can be performed at different times. For example, object sensing 130 may be performed at specified times, at different intervals, on a non-interval basis, at random times, in response to a condition (e.g., in response to user input or device movement), and so forth. In any of these cases, at least some hardware may be shared between object sensing functionality and wireless communication functionality, although such sharing need not be part of all implementations. Example aspects of object sensing functionality with configurable radar signal parameter settings are described next with reference to FIG. 4-1.

FIG. 4-1 illustrates an example scheme 400-1 for reconfiguring the radar signal parameter settings of a multimode radar based on at least one environmental factor 410 as described herein. As shown, the scheme 400-1 can include radar-signal parameter-setting determination logic 128, a radar system 408, and at least one configuration command 402. The radar-signal parameter-setting determination logic 128 can generate the configuration command 402 based on the at least one environmental factor 410 (e.g., a contemporaneous factor that is relevant to radar operation). At least one environmental factor 410 can include at least one condition 410-1 (e.g., an ambient condition), at least one activity 410-2 (e.g., a current activity), or at least one user input 410-3 (e.g., indicative of a radar-related application). The at least one environmental factor 410 can also include two or more of such example factors or other factors in accordance with a permitted, but optional, inclusive-or interpretation of the disjunctive word “or.” In example implementations, the scheme 400-1 also includes multiple collections of radar signal parameter settings 406-1 . . . 406-S, with S representing a positive integer greater than one, and multiple radar applications 404-1 . . . 404-R, with R representing a positive integer greater than one. The values of S and R may be the same or different from each other. Examples of the multiple radar applications 404-1 to 404-R include vehicle detection (e.g., while bike riding), human detection (e.g., for alarm or security purposes), gesture detection (e.g., to enable gesture control of a device), and so forth. Radar application examples are described further with reference to FIGS. 7-1 and 7-2. Multiple environmental factors are described below.

Each collection of radar signal parameter settings 406 includes values for two or more radar signal parameters. Examples of radar signal parameters are described below with reference to FIG. 4-2, and such examples include frequency bandwidth, transmit power, dwell time, and pulse repetition interval. In some cases, a respective collection of radar signal parameter settings 406 corresponds to a respective radar application 404, as represented by the double-headed arrows. In other cases, a collection of radar signal parameter settings 406 can correspond to at least one environmental factor 410. In still other cases, a collection of radar signal parameter settings 406 may correspond to at least one environmental factor 410 and to at least one radar application 404. Generally, a multi-dimensional matrix can map radar applications and/or environmental factors to one or more collections of radar signal parameter settings. Such a multi-dimensional matrix may be stored in memory, realized with logic circuitry, used by or included as part of a modem, some combination thereof, and so forth. In other examples, a collection of radar signal parameter settings 406 may be determined to optimize one or more functions of a device 102 or to achieve one or more performance characteristics. For example, a neural processing engine or processor configured to evaluate information using an artificial intelligence model may be configured to optimize power of the device (e.g., lowest power, most efficient use of power for an expected range of objects being detected, etc.) or performance (e.g., the best or acceptable settings to detect a particular type of object like a ball at an expected speed or to discern the features of a particular type or expected object with a desired resolution, optionally moving at an expected speed or within an expected range).

In some implementations, a condition 410-1 may comprise an ambient condition, and examples can include a time, a weather condition, or a location of a computing device. For example, a camera, a thermometer (e.g., an ambient temperature sensor), an anemometer, and/or a humidity sensor may be used to sense a weather condition. Additionally or alternatively, an SPS chip and/or a Wi-Fi® chip (or other part of a wireless transceiver) may be used to sense a location. To determine a location, a base station (BS) or access point (AP) identifier can be mapped to a geospatial position. To determine a weather condition, instead of using a “direct” sensing action with an onboard sensor, one or more current weather conditions may be obtained (e.g., looked up) based on a determined location using a weather application or web site. An activity 410-2 may comprise a current activity, and examples can include a calendar event or a movement of the computing device. For example, an accelerometer, a gyroscope, an IMU, and/or an SPS chip may be used to sense small-scale or large-scale movement of the computing device. A user input 410-3 may comprise an indication (e.g., a vocal utterance, a touch of a display screen or physical button, or a gesture) of a command identifying a selected radar application 404. For example, a microphone, a camera, a touch sensor, a button, and/or an accelerometer can be used to sense input from a user. Such a radar application 406 can also pertain to a desired range (e.g., distance) of monitoring with radar to potentially detect objects. An example of radar applications and user input are described further with reference to FIGS. 7-1 and 7-2. As used herein, unless context dictates otherwise, a “contemporaneous” environmental factor refers to the existence of a factor that is present or extant or to the likely existence of a factor that is anticipated to occur in the near future (e.g., starting in a few seconds to a few minutes and extending therefrom for some period based on the factor).

In example operations, radar-signal parameter-setting determination logic 128 obtains a radar application 404 for a type or function of object sensing. The radar application 404 may be selected by a user as the user input 410-3. Additionally or alternatively, the radar application 404 may be selected by an executing software program, by an operating system, by code based on ambient conditions 410-1 (e.g., location, mobile device speed, or calendar schedule), based on a current activity 410-2, some combination thereof, and so forth. Example applications for a radar application 404 include gesture recognition, human/animal detection, vehicle detection, speed detection, and so forth.

Thus, with respect to an indicated radar application 404 (e.g., from user input 410-3 or another environmental factor 410), the radar-signal parameter-setting determination logic 128 determines a matching radar application 404 and ascertains the corresponding collection of radar signal parameter settings 406. The radar-signal parameter-setting determination logic 128 issues the configuration command 402 that causes the radar system 408 to operate in accordance with the ascertained collection of radar signal parameter settings 406. Thus, the radar system 408 emanates a radar transmit signal 208 using the collection of radar signal parameter settings 406 as configured based on the indicated radar application 404. Examples of a radar system 408 are described below with reference to FIGS. 5, 6, and 9. Next, however, this document describes examples of radar signal parameters that can be part of a collection of radar signal parameter settings 406 with reference to FIG. 4-2.

FIG. 4-2 illustrates example radar signal parameters 400-2 that can be reconfigured for multipurpose object sensing. By way of explanation, the radar signal parameters 400-2 are categorized as signal-related radar signal parameters 420 and radar-related radar signal parameters 430. As used herein, radar signal parameters 400-2 refer to different parameters (e.g., characteristics) that can be changed for at least a radar transmit signal. Radar signal parameter settings refer to different values that may be applied to the radar signal parameters 400-2.

Examples of signal-related radar signal parameters 420 include a frequency range 422 (e.g., a frequency band such as 24 GHz or 60 GHz), a frequency bandwidth 424 (e.g., a frequency width of 1 GHz or 3 GHz), transmit power 426 (e.g., 2 decibel-milliwatts (dBm) or 20 dBm), and so forth. These signal-related radar signal parameters 420 are parameters that may be applicable to other, non-radar signaling, such as wireless communication signaling.

Radar-related radar signal parameters 430, on the other hand, are parameters that are at least primarily applicable to radar signaling. Examples of radar-related radar signal parameters 430 include a chirp duration 434 (D_{Chirp}) of a chirp 432 and a pulse repetition interval 436 (τ_{PRI}). The pulse repetition interval (PRI) 436 can be measured between any two same or corresponding points across two consecutive (or adjacent) chirps (e.g., a first chirp 432-1 and a second chirp 432-2). These two consecutive points may be, for example, the “peak” when the frequency switches from increasing to decreasing (as shown in FIG. 4-2) or the “start” of when a chirp begins to transmit and increase frequency. Although not so illustrated, a chirp 432 may alternatively start by decreasing frequency, and need not both increase and decrease in frequency.

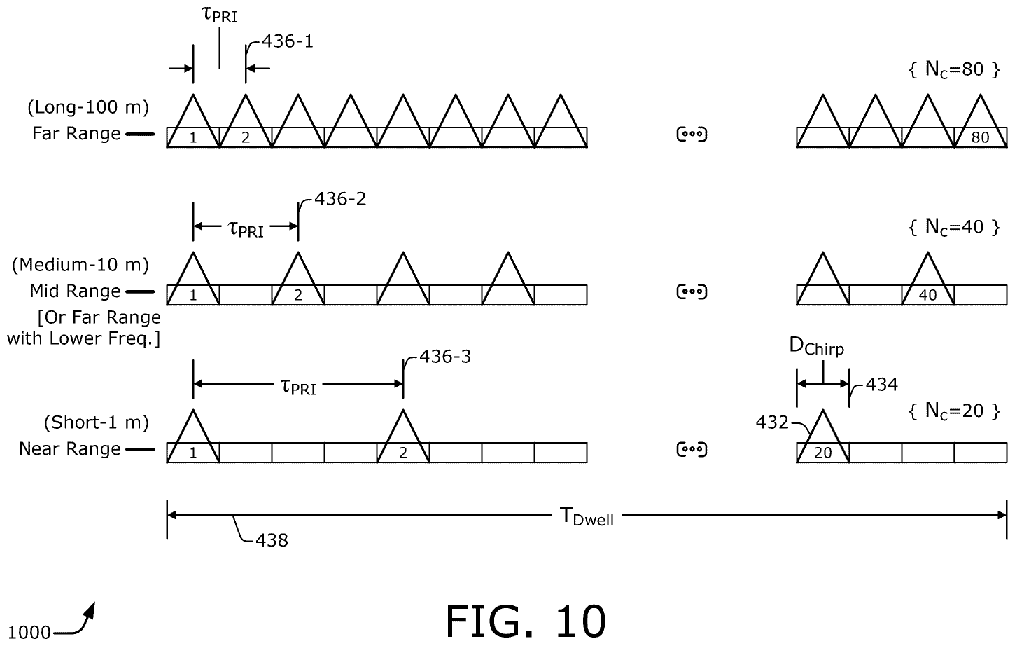

Other examples of radar-related radar signal parameters 430 include a dwell time 438 (T_{Dwell}) and a number of chirps per dwell time 440 (N_{C}). The dwell time 438 is a length of time over which multiple chirps are transmitted, such as a duration for which the multiple chirps are transmitted according to the pulse repetition interval 436. For a given dwell time 438, the number of chirps per dwell time 440 is dependent on the chirp duration 434 and the pulse repetition interval 436. Examples of this dependence are described below with reference to FIG. 10.

Another example of a radar-related radar signal parameter 430 is a frame time 442 (T_{F}). The frame time 442 can represent a time period between successive dwell times 438 (e.g., between the starting times of two adjacent dwell times). If there is a “delay” between the end of one dwell time 438 and the start of a successive dwell time 438 (e.g., as illustrated in the example of FIG. 4-2), the frame time 442 can exceed the dwell time 438. Another parameter that can be set (e.g., established or tuned) for a radar transmit signal relates to codebook settings 450. Examples of codebook settings 450 include the selection of transmit/receive layers and/or antennas.

FIG. 4-3 is a flow diagram illustrating an example process 400-3 for sensing objects using radar signal parameter settings that are reconfigured based on at least one environmental factor. The process 400-3 includes four blocks 462-468 that specify operations that can be performed for a method. However, operations are not necessarily limited to the order shown in the figures or described herein, for the operations may be implemented in alternative orders or in fully or partially overlapping manners. Also, more, fewer, and/or different operations may be implemented to perform a respective process or an alternative process.

In example implementations, operations represented by the illustrated blocks of each process may be performed by an electronic device, such as the computing device 102 of FIG. 1 (e.g., a mobile device, such as a cell phone). More specifically, the operations of the respective processes may be at least partially performed, for instance, by a radar-signal parameter-setting determination logic 128 and a radar system 408. The description of this flow diagram references other figures by way of example only.

At block 462, an environmental factor related to a mobile device or a user thereof is ascertained. For example, radar-signal parameter-setting determination logic 128 can ascertain at least one environmental factor 410 from a memory, an application, an operating system, a user input, a sensor, a combination thereof, and so forth. At block 464, a collection of radar signal parameter settings is determined based on the environmental factor. For example, the logic can determine a collection of radar signal parameter settings 406 based on the at least one environmental factor 410. For instance, a radar-related application that is being (or will be) performed or otherwise executed by the mobile device can be determined.

Determining the collection of radar signal parameter settings 406 (as part of block 464) can include, at block 464-1, selecting signal-related radar signal parameter settings. For example, such settings can be selected for signal-related radar signal parameters 420, which are described above with reference to FIG. 4-2. Determining the collection of radar signal parameter settings 406 (as part of block 464) can additionally or alternatively include, at block 464-2, selecting radar-related radar signal parameter settings. For example, such settings can be selected for radar-related radar signal parameters 430, which are also described above with reference to FIG. 4-2. Determining the collection of radar signal parameter settings 406 (as part of block 464) can also or instead include selecting codebook settings 450.

At block 466, a dwell time of chirps and sample capturing is triggered. For example, radar-related logic can trigger a dwell time 438 including N_{C} chirps 440 (a number of chirps per dwell time 440). The dwell time 438 can entail transmitting at least one radar transmit signal 208 having the N_{C} chirps 440. The logic can also capture samples of a radar receive signal 210 at a sampling frequency (f_{S}). At block 468, batched signal processing is triggered. For example, the logic can process a batch of some quantity of samples, which quantity can correspond to those samples obtained during one frame time 442. The processing can include object sensing using the batched samples. The operations of block 466 and 468 can be repeated each frame time 442 (T_{F}).

FIG. 5 illustrates examples of a wireless transceiver 120, an object sensing unit 124, radar-signal parameter-setting determination logic 128, and a modem 126 that can perform multimode radar reconfiguring. The wireless transceiver 120 can be implemented as a direct-conversion transceiver or a superheterodyne transceiver. In the depicted configuration, the wireless transceiver 120 includes a transmitter 502 and a receiver 504. The transmitter 502 is coupled between the modem 126 and the antenna array 212. The transmitter 502 is shown to include at least one signal generator 506, at least one digital-to-analog converter (DAC) 508, at least one mixer 510-1, and at least one amplifier 512-1 (e.g., a power amplifier).

The signal generator 506 can generate a digital signal (e.g., a transmit signal 522), which may be used to derive the radar transmit signal 208 or the uplink signal 202 (of FIGS. 2 and 3). Although shown separately, the signal generator 506 or a portion thereof may be implemented in the modem 126. The transmitter 502 can be connected to at least one feed port (not explicitly shown) of the antenna 122-1, such as at least one differential feed port of a dipole antenna, at least one polarized feed port of a patch antenna, or at least one directional feed port of a bowtie antenna. In some examples, the radar transmit signal 208 is generated directly in an RF circuit without use of the digital signal 522 or the signal generator 506.

The receiver 504 is coupled between the antenna array 212 and the object sensing unit 124 or the radar-signal parameter-setting determination logic 128. In general, the receiver 504 may include at least two channels 514 (or layers), which are coupled to different feed ports of one or more antennas 122. In the depicted configuration, channels 514-1 and 514-2 represent two parallel channels within the receiver 504 that are respectively connected to two feed ports of the antenna 122-2. In some cases, the two feed ports may be polarized differently (e.g., with one a vertical (V) polarization and one a horizontal (H) polarization). Although a single antenna 122-2 is shown to be connected to the two channels 514-1 and 514-2, the channels 514-1 and 514-2 can alternatively be respectively connected to two different antennas 122, such as the second antenna 122-2 and the Nth antenna 122-N of FIG. 2. The channels 514-1 and 514-2 respectively include at least one amplifier 516-1 or 516-2 (e.g., a low-noise amplifier), at least one mixer 518-1 or 518-2, and at least one analog-to-digital converter (ADC) 520-1 or 520-2. Although depicted separately, the DAC 508 and/or the ADCs 520 may be implemented as part of the modem 126.

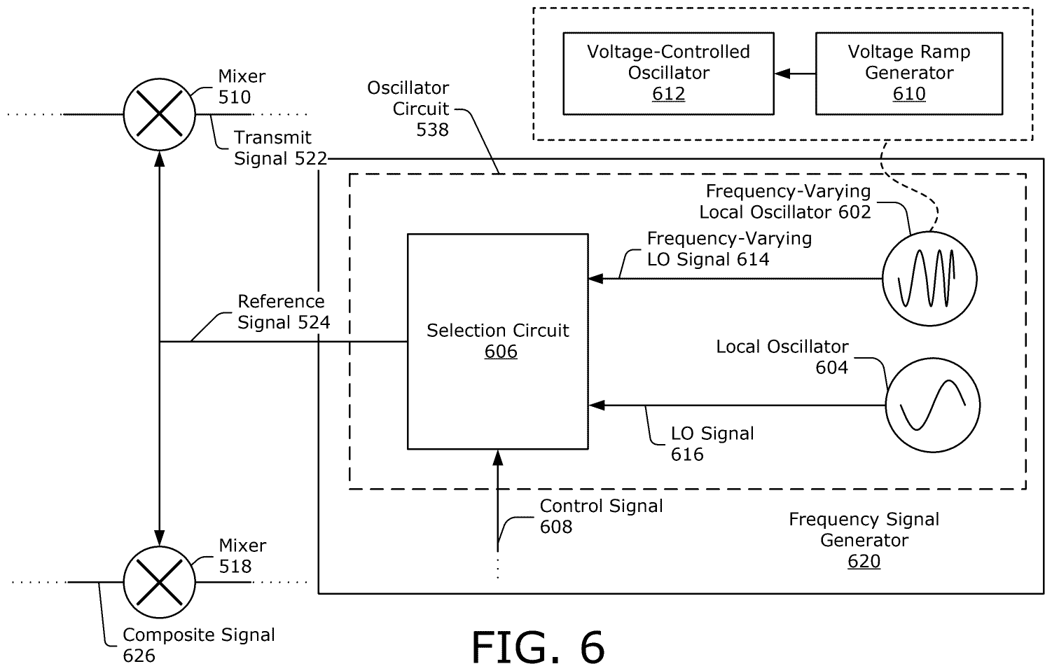

The wireless transceiver 120 also includes an oscillator circuit 538 (e.g., a local oscillator circuit), which generates a reference signal 524 enabling the mixers 510-1, 518-1, and 518-2 to upconvert or downconvert analog signals within the transmitter 502 or the receiver 504, respectively. In some implementations, the oscillator circuit 538 includes two oscillators and a selection circuit. The two oscillators can include a local oscillator, which generates a local oscillator signal having a continuous tone, and a frequency-varying local oscillator (e.g., a voltage-controlled oscillator), which generates a frequency-modulated signal or other signal which varies in frequency. During operation, the selection circuit selectively passes the frequency-varying signal or the local oscillator signal as the reference signal 524. An example of an oscillator circuit 538 that includes two oscillators and a selection circuit is described below with reference to FIG. 6. The transmitter 502 and the receiver 504 can also include other additional components that are not depicted in FIG. 5, such as filters (e.g., low-pass filters or band-pass filters), phase shifters, additional mixers, switches, and so forth.

During wireless communication 132, the wireless transceiver 120 can transmit the uplink signal 202 or receive the downlink signal 204 (of FIGS. 2 and 3). In particular, for transmission, the signal generator 506 generates the transmit signal 522, which includes communication data for wireless communication 132. The digital-to-analog converter 508 converts the transmit signal 522 from the digital domain to the analog domain. The oscillator circuit 538 generates the local oscillator signal as the reference signal 524. The mixer 510-1 upconverts the transmit signal 522 to radio frequencies using the reference signal 524. The amplifier 512-1 amplifies the radio-frequency transmit signal 522, and the antenna 122-1 transmits the amplified transmit signal 522 as the uplink signal 202 (of FIGS. 2 and 3).

During wireless communication 132 (e.g., of FIGS. 1 and 2), the antenna 122-2 can receive the downlink signal 204 (of FIG. 2). At least one of the receive channels within the receiver 504 processes the downlink signal 204. For example, the amplifier 516-1 amplifies the downlink signal 204, and the mixer 518-1 downconverts the amplified downlink signal 204 using the reference signal 524, which is the local oscillator signal for wireless communication 132 in this scenario. The analog-to-digital converter 520-1 converts the downlink signal 204 from the analog domain to the digital domain to produce a receive signal 526-1. The digital version of the downlink signal 204 can be passed to the modem 126 or a data processor that is part of, or otherwise associated with, the modem for further processing. Although not explicitly depicted this way in FIG. 5, the object sensing unit 124 or the radar-signal parameter-setting determination logic 128, including both based on a permitted inclusive-or interpretation of the disjunctive “or,” can be bypassed during wireless communication 132.

During object sensing 130 (e.g., of FIGS. 1 and 2), which can include proximity detection, the transmitter 502 generates the radar transmit signal 208 via the antenna 122-1. In particular, the signal generator 506 can generate the transmit signal 522, which can include a single continuous tone. The digital-to-analog converter 508 converts the transmit signal 522 from the digital domain to the analog domain. The oscillator circuit 538 generates the frequency-modulated signal as the reference signal 524. The mixer 510-1 upconverts and modulates the analog transmit signal 522 using the reference signal 524—e.g., to produce a frequency-modulated radio-frequency transmit signal 522. The amplifier 512-1 amplifies this transmit signal 522, and the antenna 122-1 transmits the amplified transmit signal 522 as the radar transmit signal 208.

The antenna 122-2 can receive the radar receive signal 210, which may include a reflected signal 216, or a reflected signal component. The receiver 504 may receive different versions 540 of the radar receive signal 210 via the antenna 122-2. To do so, the response of the antenna 122-2 can be separated into the versions 540-1 and 540-2 via two feed ports (not explicitly shown). Using the mixers 518-1 and 518-2, the channels 514-1 and 514-2 of the receiver 504 demodulate the radar receive signal 210 using the reference signal 524. As a result of the mixing operations, the mixers 518-1 and 518-2 produce down-converted radar receive signals that propagate as receive signals 526-1 and 526-2, respectively. These receive signals 526-1 and 526-2 may be converted into digital versions of the signals 526-1 and 526-2 using the ADCs 520-1 and 520-2, respectively, as shown.

The receive signals 526-1 and 526-2 can include a beat frequency, which is indicative of a frequency offset between the radar transmit signal 208 and the radar receive signal 210. The beat frequency may have one or more components or characteristics that are indicative of a range to, or other attribute of, the object 206 that are determinable by the object sensing unit 124. The radar receive signal 210, and a resulting receive signal 526, may also or instead include a direct coupling component caused by a direct coupling signal 528 that propagates between the antenna 122-1 and the antenna 122-2 within or outside of a housing of a computing device.

In example implementations, the object sensing unit 124 can accept the first receive signal 526-1 or the second receive signal 526-2. In some cases, the first receive signal 526-1 or the second receive signal 526-2 can also be coupled to the radar-signal parameter-setting determination logic 128. Responsive to detection of an object, the object sensing unit 124 can generate an object indication 534 signal and provide the object indication 534 signal to the transmission control unit 532 to meet an MPE requirement or to other circuitry. The other circuitry can report the object indication 534 (e.g., presence, distance, direction) to an operating system or application of the computing device.

In example operations, the radar-signal parameter-setting determination logic 128 can receive at least one environmental factor indication 542 (EF indication 542). The environmental factor indication 542 can indicate the relevance of at least one environmental factor 410. The radar-signal parameter-setting determination logic 128 can receive the environmental factor indication 542 from an operating system or application (e.g., as directed by user input), from memory, from a sensor, a combination thereof, and so forth. Based on the at least one environmental factor indication 542, the radar-signal parameter-setting determination logic 128 can produce a configuration command 402. The configuration command 402 can indicate at least one collection of radar signal parameter settings 406 (e.g., of FIG. 4). The radar-signal parameter-setting determination logic 128 can provide the configuration command 402 to, for example, the transmission control unit 532. The radar-signal parameter-setting determination logic 128 can also or instead provide the configuration command 402 to the object sensing unit 124.

Thus, the transmission control unit 532 can accept the configuration command 402 from the radar-signal parameter-setting determination logic 128. In this way, the radar-signal parameter-setting determination logic 128 can control, at least partially, the parameter settings used to emanate the radar transmit signal 208. For example, the transmission control unit 532 can control operation of the transmitter 502 or the oscillator circuit 538 in accordance with the collection of radar signal parameter settings 406 that correspond to the configuration command 402. To do so, the transmission control unit 532 can use a transmission parameter 536 signal to control aspects of the radar transmit signal 208. Although not explicitly depicted in FIG. 5 in this manner, a transmission parameter 536 can also be routed to the oscillator circuit 538, or a frequency signal generator 620, which is described below with reference to FIG. 6.

In FIG. 5, the modem 126 is depicted to include at least one object sensing unit 124 and at least one transmitter control unit 532 (TX control unit 532). Although not shown in FIG. 5, the modem 126 can include other components, such as the illustrated radar-signal parameter-setting determination logic 128 or unillustrated components. With respect to object detection by the object sensing unit 124 in the context of mitigating MPE, the transmitter control unit 532 can generate at least one transmission parameter 536 that controls one or more transmission attributes for wireless communication 132. The transmission parameter 536 can specify one or more transmission-related aspects of the uplink signal 202, such as a power level, polarization, frequency, duration, beam shape, beam steering angle, a selected antenna that transmits the uplink signal 202 (e.g., another antenna that is on a different surface of the computing device 102 and is not obstructed by the object 206), or combinations thereof. Some transmission parameters 536 may be associated with beam management, such as those that define an unobstructed volume of space for beam sweeping.

With respect to proximity detection for MPE purposes, in some situations, the object 206 may be closer to one of the antennas 122 than another, which enables the one antenna 122 to detect the object 206 while the other antenna 122 is unable to detect the object 206. In this case, the transmitter control unit 532 can decrease a transmit power of the antenna 122 that detected the object 206 relative to the other antenna 122. In some implementations, the multiple antennas 122 can be used to further characterize the relationship between the object 206 and the antennas 122, such as by using triangulation or digital beamforming to estimate an angle to the object 206. In this way, the transmitter control unit 532 can adjust the transmission parameter 536 to steer the uplink signal 202 away from the object 206. The estimated angle to the sensed object 206 can also be provided to a radar-related application that is executing on the computing device for further processing of attributes of the sensed object 206. In general, the object sensing unit 124 can detect one or more objects using at least one receive signal 526 obtained from the receiver 504.

By specifying the transmission parameter 536, the modem 126 can, for example, cause the transmitter 502 to decrease power if an object 206 is close to the computing device 102 or increase power if the object 206 is at a farther range or is not detectable. The ability to detect the object 206 and control the transmitter 502 enables the modem 126 to balance the performance of the computing device 102 with regulatory compliance guidelines with respect to MPE functionality. In other implementations, the application processor 108 or another component (e.g., a sensors hub) can perform one or more of these functions and include the object sensing unit 124.

Although not explicitly shown, multiple antennas 122 can be used to sense additional versions 540 of the radar receive signal 210 (e.g., a third version or a fourth version) or another received signal (e.g., a potential jamming signal or a downlink signal) and provide additional receive signals 526 (e.g., a third receive signal 526 or a fourth receive signal 526) to the object sensing unit 124. For example, two or more patch antennas may be used to receive the radar receive signal 210. With multiple received signals 526, the computing device 102 can increase a probability of sensing an object 206 (or accurately determining a range thereof) or decrease a probability of false alarms. The transmitter control unit 532 can also make different adjustments based on which one or more antennas 122 or what quantity or polarization of antennas 122 sense an object 206 or based on the indicated collection of radar signal parameter settings 406. In some cases, these adjustments may impact beam management by focusing available beams or targeting a spatial area for beam determination or adjusting a polarization for transmission.

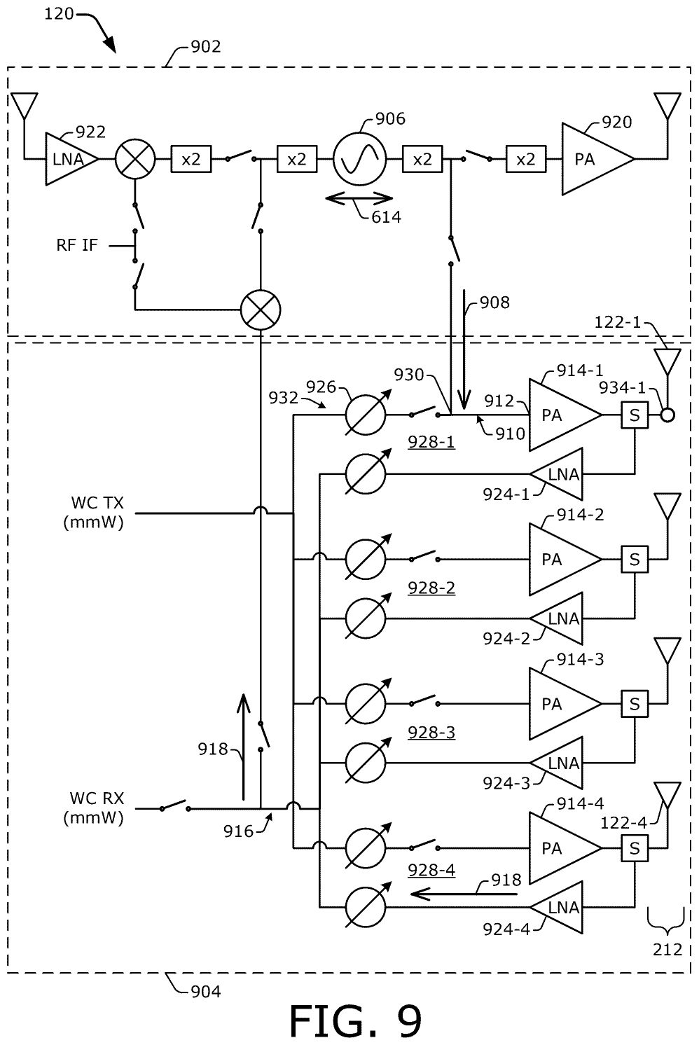

Additional example operations and functionality of the object sensing unit 124 and the radar-signal parameter-setting determination logic 128 are described below with respect to FIGS. 7-1, 7-2, 8, and 10. Additional example implementations for transmitter and receiver hardware are described below with reference to FIG. 9.

FIG. 6 illustrates an example frequency signal generator 620 having an oscillator circuit 538 for supporting wireless communication 132 in conjunction with object sensing 130 using a reconfigurable multimode radar. In the depicted configuration, the oscillator circuit 538 includes a frequency-varying local oscillator 602, a local oscillator 604, and a selection circuit 606. The frequency-varying local oscillator 602 can be implemented using, for instance, a voltage ramp generator 610 and a voltage-controlled oscillator 612. As an example, the voltage-controlled oscillator 612 can be implemented using a wideband open-loop voltage-controlled oscillator. By controlling an input voltage to the voltage-controlled oscillator 612, the voltage ramp generator 610 can provide a variety of different voltage ramps to enable the voltage-controlled oscillator 612 to generate a variety of different frequency-modulated local oscillator signals, which are an example of frequency-varying local oscillator signals 614. Examples of frequency-modulated local oscillator signals include a linear frequency-modulated (LFM) signal, a sawtooth frequency-modulated signal, a triangular frequency-modulated signal, and so forth. At least some of such frequency-modulated local oscillator signals can be used for radar signaling to perform object sensing 130.

More generally, however, the frequency-varying local oscillator 602 can produce a frequency-varying LO signal 614. In addition to a frequency-modulated LO signal, a frequency-varying LO signal 614 can include other types of frequency-varying waveforms that are produced with other components besides the voltage-controlled oscillator 612 or the voltage ramp generator 610. Examples of other types of frequency-varying signals include a signal that has discrete frequency periods or buckets (e.g., a signal that stairsteps in frequency), a signal that pulses at different frequencies, and so forth. Thus, a discontinuous frequency-varying signal can correspond to any signal that can vary between or among a targeted number of different frequencies during a given time slot, and such signals can be produced by any corresponding components. Object sensing 130 can be implemented using a frequency-varying LO signal 614, including but not limited to a frequency-modulated LO signal.

For object sensing 130, a frequency or frequencies of the frequency-varying local oscillator signal 614 can be the same across different use cases. Alternatively, in other scenarios, the frequency or frequencies of the frequency-varying local oscillator signal 614 can be different (e.g., completely non-overlapping) frequencies or the bandwidth of one can be different from the other (e.g., one may be a subset of, or overlapping with, another) between different object sensing operations. As described herein, a frequency of the frequency-varying LO signal 614 may be based at least on an environmental factor 410 for some implementations of object sensing 130. A frequency of the frequency-varying LO signal 614, however, may also or instead be based on a frequency band of signaling for wireless communication 132.

The local oscillator 604 can include, for example, a quartz crystal, an inductor-capacitor (LC) oscillator, an oscillator transistor (e.g., a metal-oxide semiconductor field-effective transistor (MOSFET)), a transmission line, a diode, a piezoelectric oscillator, and so forth. A configuration of the local oscillator 604 can enable a target phase noise and quality factor to be achieved for wireless communication 132. In general, the local oscillator 604 generates a local oscillator signal 616 (LO signal 616) with a (e.g., selectable) steady (e.g., substantially constant) frequency. Although not explicitly shown, the oscillator circuit 538 can also include a phase-lock loop (PLL) or automatic gain-control (AGC) circuit. Either of these components can be coupled to the local oscillator 604 to enable the local oscillator 604 to oscillate at a (e.g., selectable) steady frequency.

The selection circuit 606 can include a switch or a multiplexer that is controlled by the modem 126 (e.g., of FIG. 5). Based on a control signal 608, the selection circuit 606 connects or disconnects the frequency-varying local oscillator 602 or the local oscillator 604 to or from the mixers 510 and 518 (e.g., of FIGS. 5 and 9). If the control signal 608 is indicative of the wireless transceiver 120 performing object sensing 130, the selection circuit 606 can connect the frequency-varying local oscillator 602 to the mixers 510 or 518 to provide the frequency-varying local oscillator signal 614 as the reference signal 524. The reference signal 524 may be a frequency-modulated continuous wave (FMCW) signal, a frequency-varying discontinuous signal, etc. for object sensing 130.

Alternatively, if the control signal 608 is indicative of the wireless transceiver 120 performing wireless communication 132, the selection circuit 606 can connect the local oscillator 604 to the mixers 510 or 518 to provide the local oscillator signal 616 as the reference signal 524. The selection circuit 606 enables the wireless transceiver 120 to quickly transition between performing operations for object sensing 130 and performing operations for wireless communication 132.

Generally, in some cases, the reference signal 524 is continuous. In other cases, however, the reference signal 524 can be discontinuous, for example as different frequencies are changed or tuned to for targeting objects at different ranges for object sensing 130. Although the frequency-varying local oscillator 602 and the selection circuit 606 are shown in FIG. 6, other implementations of the frequency signal generator 620 or the oscillator circuit 538 thereof may not include these components. For example, the local oscillator 604 can provide the local oscillator signal 616 as the reference signal 524 for object sensing 130 and for wireless communication 132. In this case, for the object sensing 130, the modem 126 (or a signal generator, such as the signal generator 506, within the wireless transceiver 120) can apply a frequency modulation to the analog baseband signal (e.g., the transmit signal 522) to enable performance of the object sensing 130.

In other examples, respective LO circuitry for wireless communication 132 and object sensing 130 can be implemented, and respective reference signals 524 are provided to mixers 510 and/or 518 as shared for wireless communication 132 and object sensing 130, or to respective mixers. FIG. 6 also depicts a composite signal 626 that may be processed in the receive chain, such as a signal corresponding to the receive signal 526 (of FIG. 5). The composite signal 626 can include multiple components, including a reflection signal component, that are received via at least one antenna as part of some signal.

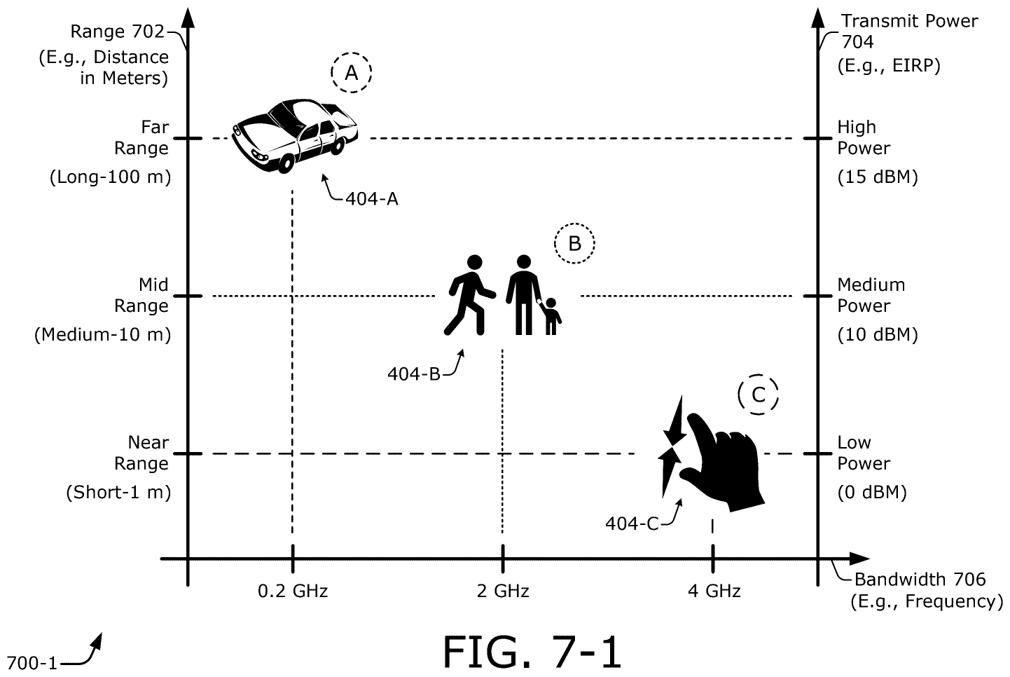

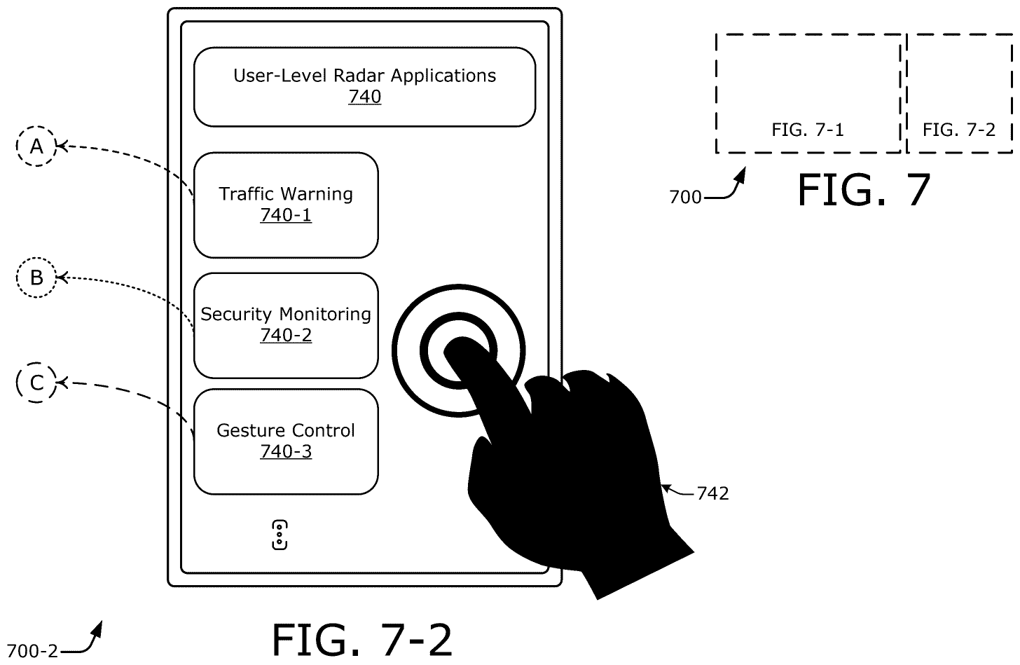

FIG. 7 illustrates a spatial relationship 700 between FIGS. 7-1 and 7-2. Accordingly, the depictions of FIGS. 7-1 and 7-2 can form a combined illustration with FIG. 7-1 on the left (as depicted) and FIG. 7-2 on the right. FIG. 7-1 illustrates an example multi-dimensional matrix 700-1 of radar signal parameter settings that is linked to multiple example radar applications. As illustrated, the multi-dimensional matrix 700-1 includes three axes. For a vertical axis on the left (as depicted), a range axis 702 increases from bottom to top in the direction of the arrow. The range is depicted, by way of example only, as a distance in meters (m) in a logarithmic scale. The range axis 702 extends from zero meters (0 m) to a near range (e.g., a short distance of approximately 1 m), and from the near range to a mid range (e.g., a medium distance of approximately 10 m). The range axis 702 extends upward still farther from the mid range to a far range (e.g., a long distance of approximately 100 m).

For a vertical axis on the right (as depicted), a transmit power axis 704 increases from bottom to top in the direction of the arrow. The transmit power is depicted, by way of example only, as equivalent isotropic radiated power (EIRP) in decibel-milliwatts (dBm). The transmit power axis 704 extends from a base to a low transmit power (e.g., of approximately 0 dBm), and from the low transmit power to a medium transmit power (e.g., of approximately 10 dBm). The transmit power axis 704 extends upward still farther from the medium transmit power to a high transmit power (e.g., of approximately 15 dBm).

For the horizontal axis, a bandwidth axis 706 increases from left to right in the direction of the arrow. The bandwidth axis 706 is depicted with varying bandwidths in which the resolution of the radar increases as the frequency widths increase. These frequency bandwidths range, by way of example only, from 0.2 GHz to 2 GHz, and from 2 GHz to 4 GHz. However, the range distances, the transmit powers, and the frequency bandwidths may have different values or available settings.

The multidimensional matrix 700-1 therefore creates a distance-bandwidth-power plane on which different radar applications can be mapped. FIG. 7-1 also depicts three example radar applications: a vehicular radar application 404-A, a person radar application 404-B, and a gesture radar application 404-C.

FIG. 7-2 illustrates an example user interface 700-2 that is generated by a computing device and that enables a user 742 to select a user-level radar application 740 from multiple example user-level radar applications 740-1, 740-2, and 740-3 that pertain to sensing objects (or, more generally, to select from multiple applications 740-1 to 740-3 related to sensing one or more objects using radar signaling). Each user-level radar application 740 can relate to a use case that is clear to the user 742. A first example is a traffic warning application 740-1 that detects vehicles, which can be useful for joggers or bike riders. A second example user-level radar application 740 is a security monitoring application 740-2 that detects people or animals, which can be useful to alerting users of an approaching entity that may be intent on causing harm. A third example is a gesture control application 740-3 that detects user gestures that are based on, for instance, movements of fingers, hands, arms, legs, and so forth.

In example implementations, with reference to FIGS. 7-1 and 7-2, a user 742 may select the traffic warning application 740-1. Based on this selection, as indicated by the encircled “A,” the computing device can be configured to sense vehicular objects as part of the vehicular radar application 404-A of FIG. 7-1. A user 742 may instead select the security monitoring application 740-2. Based on this selection, as indicated by the encircled “B,” the computing device can be configured to sense human objects as part of the person radar application 404-B. A user 742 may select the gesture control application 740-3. Based on this selection, as indicated by the encircled “C,” the computing device can be configured to sense appendages of people as part of a gesture radar application 404-C of FIG. 7-1.

Although three device-level radar applications 404 and three user-level radar applications 740 are described relative to FIGS. 7-1 and 7-2, either or both such applications can have more or fewer instantiations thereof. Further, a computing device may recognize only a single category of radar applications instead of user-level and device-level radar applications, or a computing device may recognize more than two categories of radar applications. Further, the alignment of power with bandwidth need not be implemented as illustrated; rather, any of the bandwidths may be matched with any one or more powers.

Based on a user-selected (or a device determined) radar application (e.g., as an example of an environmental factor 410 of FIG. 4), an instance of radar-signal parameter-setting determination logic 128 may determine at least one radar signal parameter setting. In some cases, transmit power is configurable based on an application. In other cases, radar bandwidth is configurable based on the application. A variable radar bandwidth can be achieved by changing the frequency range or bandwidth swept by a VCO during a chirp duration 434. In still other cases, transmit power and radar bandwidth (as well as other parameters) are configurable based on the application.

For example, for vehicle detection in accordance with a vehicular radar application 404-A, vehicle sensing can target objects in the far range along the range axis 702. To reach this long distance, the transmit power for the transmit power axis 704 can be set to a high-power level. However, because precision or resolution is relatively less important, the frequency bandwidth along the bandwidth axis 706 can be set to a relatively narrow bandwidth (e.g., <1 GHz).

As another example, for human detection in accordance with a person radar application 404-B, person sensing can target objects in the mid range along the range axis 702. To reach this medium distance, the transmit power for the transmit power axis 704 can be lowered by setting it to a medium-power level to save power. However, because precision detail or resolution becomes relatively more important, the frequency bandwidth along the bandwidth axis 706 is set to a wider bandwidth (e.g., approximately 2 GHz).

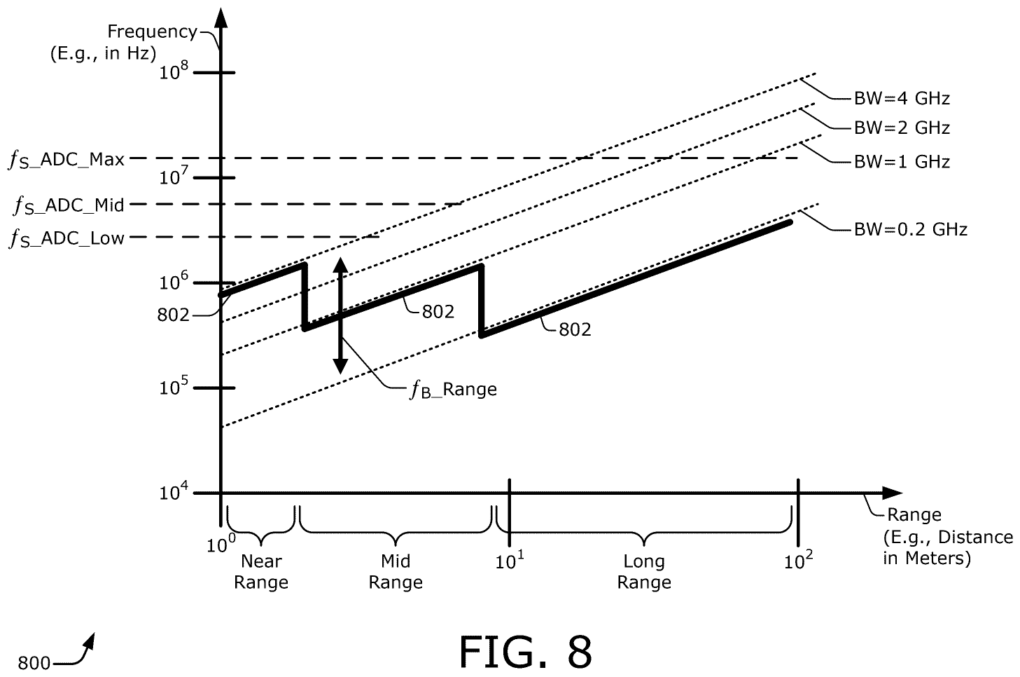

As yet another example, for small-scale human movement (e.g., gesture) detection in accordance with a gesture radar application 404-C, gesture sensing can target objects in the near range along the range axis 702. To reach this short distance, the transmit power for the transmit power axis 704 can be lowered still further by setting it to a low-power level to save more power. However, because precision detail or resolution can become even more important, the frequency bandwidth along the bandwidth axis 706 is set to a still wider bandwidth (e.g., approximately 4 GHz). By setting the frequency bandwidth inversely with increasing range (e.g., by lowering the frequency bandwidth as the range increases), the sampling frequency range (e.g., from minimum to maximum) can be controlled. This produces efficiencies for processing the samples in terms of hardware and power, which is described next with reference to FIG. 8.

FIG. 8 is a graph 800 illustrating an example approach to maintaining a beat frequency range across multiple radar applications that correspond to multiple distance ranges. The graph 800 depicts frequency (e.g., in hertz (Hz)) along the ordinate (y-axis) versus range (e.g., distance in meters) along the abscissa (x-axis). The illustrated frequency range starts at 10⁴ Hz and increases to 10⁸ Hz. The depicted distance range starts around 1 m (10⁰) and extends to 10 m (10¹) and then continues to 100 m (10²). The horizontal range axis is separated into a near range (e.g., <2 m), a middle range (e.g., 2 m to 9 m), and a long range (e.g., 9 m to 100 m or more). However, alternative or additional ranges may be used.

As described herein, a reconfigurable radar system can be realized with multiband, multi-bandwidth, multi-pulse-periodicity, and/or variable-transmit-power radar hardware. The reconfigurable radar system can dynamically adjust transmission parameters for a radar signal during operation responsive to an application that is selected by the user. For example, the chirp (or pulse) bandwidth can be modified according to an expected detection distance (e.g., according to a maximum targeted range) associated with the selected application. For longer range applications, for instance, a relatively lower radar bandwidth is suitable to reduce or limit the maximum observable beat frequency (f_{B}). This in turns limits the sampling frequency (f_{S}). By lowering the sampling frequency, the power consumption of the computing device and the sample memory size can likewise be lowered as there can be fewer samples to process. Further, implementing a common range of beat frequency values (f_{B}_min value, f_{B}_max value) across different radar applications enables use of a single sampling frequency value (f_{S} value) in the computing device, which can simplify the design to further lower design or hardware costs.

Continuing with the graph 800, three example sampling frequencies (fₛ) are denoted along the frequency axis. These sampling frequencies correspond to example low, middle, and maximum frequencies (f_{S}_ADC_low, f_{S}_ADC_mid, and f_{S}_ADC_max) for an ADC that is to sample the beat frequency (f_{B}) associated with a radar receive signal. Each of these sampling frequency (f_{S}) levels is depicted with a long-dashed horizontal line. Constant radar bandwidth lines are depicted with short-dashed diagonal lines. Example radar bandwidths correspond to 0.2 GHz, 1 GHz, 2 GHz, and 4 GHz. At any given frequency bandwidth, the beat frequency f_{B} increases as the range increases.

Consider the bandwidth line for BW=4 GHz, in the near-and middle-range distances, the beat frequency (f_{B}) remains below the maximum sampling frequency of the ADC (f_{S}_ADC_max). In the long-range distance, however, the maximum sampling frequency of the ADC is exceeded with the 4 GHz bandwidth. This situation could render the radar system inoperative at longer ranges, or the radar system sampling and processing hardware would need to be enhanced. As described herein, however, the radar bandwidth can instead be reduced to keep the beat frequency (f_{B}) below the maximum sampling frequency of the ADC.

In a depicted example implementation, different frequency bandwidth lines are associated with different distance ranges. This is shown with the solid thick line 802. In the near range, the 4 GHz bandwidth is employed. The radar system reconfigures for the 1 GHz bandwidth if the targeted object is located in the middle range. If the determined radar application is targeting long-range objects, logic (e.g., radar-signal parameter-setting determination logic 128) reduces the bandwidth further, such as to the illustrated 0.2 GHz bandwidth. This maintains the beat frequency (f_{B}) within a given beat frequency range (f_{B}_range) as shown in FIG. 8. Additionally or alternatively, a sampling rate (f_{S}) of an analog-to-digital converter (ADC) can be lowered. The lowering of the sampling rate (f_{S}) can reduce power consumption in the ADC or in the digital signal processor (DSP) that processes the samples, including lowering power consumption in the ADC and in the digital signal processor. This lowering of the sampling rate (f_{S}) can also lower a size or an input/output bandwidth of a memory that stores the samples. In some cases, the sampling rate may be lowered to the Nyquist rate.

FIG. 9 illustrates an example wireless transceiver 120 that includes an example radar signaling path 902 for radar operations and an example shared signaling path 904 for radar operations and wireless communications. In example implementations, an oscillator 906 can be shared across two or more radar bands, such as 24 GHz and 60 GHz. For instance, the oscillator 906 can oscillate between 12 GHz and 15 GHz. At 12 GHz, one frequency doubler (x2) in a signal pathway (e.g., a TX or RX signal pathway) can produce a 24 GHz frequency. At 15 GHz, two frequency doublers (x2) in a signal pathway can produce a 60 GHz frequency for transceiving radar signals using the two antennas at the top of the figure (as depicted) that can be part of, or otherwise associated with, the radar signaling path 902. This saves space by reusing the oscillator 906 for multiple radar bands.

In an example aspect, a TX signal 908 can be injected near (e.g., at or right before) an input 912 of a power amplifier 914-1 in the shared signaling path 904 to reduce (e.g., minimize) noise from other components in the transmit chain. In another example aspect, there is a point of injection 910 for the TX signal 908 and a point of extraction 916 for a RX signal 918 in 24 GHz radar mode. While reusing a phased antenna array 212 (that is also for wireless communication), these two points can be implemented such that the TX and RX radar signals do not couple to each other on-chip, or at least so as to reduce such coupling by physically separating the two pathways as much as possible given the layout for the antenna array 212 or other circuitry.

The illustrated example implementation for a shared antenna array 212 includes four elements, but a phased array antenna system can alternatively include more or fewer antenna elements. In some aspects, the two antenna elements 122-1 and 122-4 that are farthest from each other are chosen to obtain maximum isolation from mutual coupling of the radar TX and RX signals. With more elements available in the antenna array, the choice of TX and RX pathways and points of injection/extraction likewise increase. The components represented by a square with an “S” correspond to switches for transmit versus receive modes.

In example implementations, the wireless transceiver 120 includes the radar signaling path 902 with a power amplifier 920 and a low-noise amplifier 922. The radar signaling path 902 corresponds to a first frequency range. The wireless transceiver 120 also includes the shared signaling path 904 with multiple power amplifiers 914-1 to 914-4 and multiple low-noise amplifiers 924-1 to 924-4. The shared signaling path 904 can be configured to be coupled to an antenna array 212. Although the radar signaling path 902 and the shared signaling path 904 are shown in FIG. 9 as including antenna elements, the antenna elements may alternatively be separate from the signaling paths (e.g., may be considered separate component(s) that are connected to the signaling paths during manufacturing). The shared signaling path 904 corresponds to a second frequency range that is different from the first frequency range.

In example aspects, the first frequency range (e.g., 60 GHz) is higher than the second frequency range (e.g., 24 GHz). The shared signaling path 904 can transceive radar signals (e.g., also using one or more components of the radar signaling path 902) and wireless communication signals (e.g., using the wireless communication transmit (WC TX) port and the wireless communication receive (WC RX) port). Although the shared signaling path 904 includes four pairs of amplifiers (e.g., a power amplifier and a low-noise amplifier pair) for the four antenna elements, the quantity of amplifier pairs may be more than or less than four.

In example aspects, the wireless transceiver 120 includes a frequency-varying local oscillator (e.g., the oscillator 906 or the frequency-varying local oscillator 602 of FIG. 6) that produces a frequency-varying local-oscillator signal 614. In operation, the radar signaling path 902 transmits first radar transmit signals in the first frequency range (e.g., using the power amplifier 920) based on the frequency-varying local-oscillator signal 614. Further, the shared signaling path 904 transmits second radar transmit signals (e.g., the radar TX signal 908) in the second frequency range also based on the frequency-varying local-oscillator signal 614. As shown in FIG. 9, the radar signaling path 904 can inject the frequency-varying local-oscillator signal 614 (e.g., after frequency doubling) into the shared signaling path 904 by bypassing one or more phase shifters 926 that precede, along a signal propagation pathway 928-1 of the shared signaling path 904, a power amplifier 914-1 of the multiple power amplifiers 914-1 to 914-4.

In example aspects, the multiple power amplifiers 914-1 to 914-4 and the multiple low-noise amplifiers 924-1 to 924-4 of the shared signaling path 904 include multiple pairs of amplifiers (e.g., an amplifier pair 914-1 and 924-1 and an amplifier pair 914-3 and 924-3). Each pair of amplifiers of the multiple pairs of amplifiers include a power amplifier 914 of the multiple power amplifiers 914-1 to 914-4 and a low-noise amplifier 924 of the multiple low-noise amplifiers 924-1 to 924-4. Each respective pair of amplifiers of the multiple pairs of amplifiers is configured to be coupled to a respective antenna element of the antenna array (e.g., an antenna 122 of the antenna array 212, also of FIG. 2). In FIG. 9, the pairs of amplifiers are shown already coupled to respective antenna elements. The shared signaling path 904 transmits radar transmit signals (e.g., the radar TX signal 908) using a power amplifier 914-1 of a first pair of amplifiers 914-1 and 924-1 of the multiple pairs of amplifiers. The shared signaling path 904 receives radar receive signals (e.g., the radar RX signal 918) using a low-noise amplifier 924-4 of a second pair of amplifiers 914-4 and 924-4 of the multiple pairs of amplifiers. As shown, a physical separation can decrease coupling between the TX and RX radar signals on a circuit board or chip. Further, a third pair of amplifiers (e.g., an amplifier pair 914-2 and 924-2 or an amplifier pair 914-3 and 924-3) of the multiple pairs of amplifiers is physically disposed between the first pair of amplifiers 914-1 and 924-1 of the multiple pairs of amplifiers and the second pair of amplifiers 914-4 and 924-4 of the multiple pairs of amplifiers.

In example aspects, the radar signaling path 902 is coupled to the shared signaling path 904 at a node 930 that is coupled between a phase shifter 926 of the shared signaling path 904 and a power amplifier 914-1 of the multiple power amplifiers 914-1 to 914-4 of the shared signaling path 904. In some cases, the shared signaling path 904 includes a transmission pathway 932 (e.g., a portion of the signal propagation pathway 928-1 that includes the power amplifier 914-1). The transmission pathway 932 includes the phase shifter 926, the node 930, and the power amplifier 914-1 of the multiple power amplifiers 914-1 to 914-4 of the shared signaling path 904. As shown, the transmission pathway 932 can lack another phase shifter between the node 930 and an input 912 of the power amplifier 914-1 of the multiple power amplifiers 914-1 to 914-4 of the shared signaling path 904. In other cases, the shared signaling path 904 includes a transmission pathway 932. Here, the transmission pathway 932 includes the phase shifter 926, the node 930, the power amplifier 914-1 of the multiple power amplifiers 914-1 to 914-4 of the shared signaling path 904, and an antenna port 934-1 for an antenna element 122-1 of the antenna array 212. As shown, the transmission pathway 932 lacks another power amplifier between the power amplifier 914-1 and the antenna port 934-1 of the transmission pathway 932. These two example cases may also be combined.

FIG. 10 illustrates example radar signal parameter settings 1000 that can be reconfigured for different radar applications across at least one dwell time 438. Each dwell time 438 has a length that can accommodate up to 80 chirps (or pulses) 432 with each chirp 432 having a chirp duration of 434. By way of example only, a radar transmit signal for far-range object sensing can include 80 chirps (N_{C}=80) across the dwell time 438. With this parameter arrangement, the pulse repetition interval 436-1 is 1/80 of the dwell time 438. A radar transmit signal for mid-range object sensing can include 40 chirps (N_{C}=40) across the dwell time 438. With this parameter arrangement, the pulse repetition interval 436-2 is 1/40 of the dwell time 438, or twice as long. A radar transmit signal for near-range object sensing can include 20 chirps (N_{C}=20) across the dwell time 438. With this parameter arrangement, the pulse repetition interval 436-3 is 1/20 of the dwell time 438, which is four times longer than the pulse repetition interval 436-1.

In these manners, the pulse repetition interval 436 can be changed to match a pulse velocity that supports the object-sensing task associated with a specific application. Generally, the chirp density can be increased (e.g., by lowering the pulse repetition interval 436 and increasing the number of chirps per dwell time 440) to increase the maximum sensing range and the signal velocity as the range increases (e.g., from near range to far range).

In some cases, the example radar signal parameter settings 1000 of FIG. 10 can correspond to a relatively higher frequency band (e.g., 60 GHz). In at least some of such cases, the radar-signal parameter-setting determination logic 128 can switch the radar system 408 to operate at a relatively lower frequency band (e.g., 24 GHz). By doing so, the far range can be sensed for objects using radar transmit signals with 40 chirps (N_{C}=40) per dwell time 438. This lower frequency can be effective at the longer range by providing a superior performance/power tradeoff due to an 8 dB gain in the path-loss (e.g., if switching from 60 to 24 GHz) and 2.5× maximum velocity increase. Further, the VCO phase noise may be lower (e.g., by approximately 12 dB) with the lower frequency.

By way of example only, across the different ranges, the chirp duration 434 can be 62.5 microseconds (us), which can correspond to a 31.25 microsecond ramp duration. Accordingly, with a maximum of 80 chirps in this example, the dwell time 428 can be 5 milliseconds (ms). As indicated in FIG. 10, the pulse repetition interval 436 changes for each range. For the higher frequency range (e.g., 60 GHz), the pulse repetition interval 436-3 of the near range can be 250 microseconds. The pulse repetition interval 436-2 of the mid range can be 125 microseconds (half as long as for the near range), and the pulse repetition interval 436-1 of the far range can be 62.5 microseconds (one quarter as long as for the near range). If the frequency is lowered (e.g., to 24 GHz) for far-range object sensing, the pulse repetition interval 436-2 is again 125 microseconds for this example.

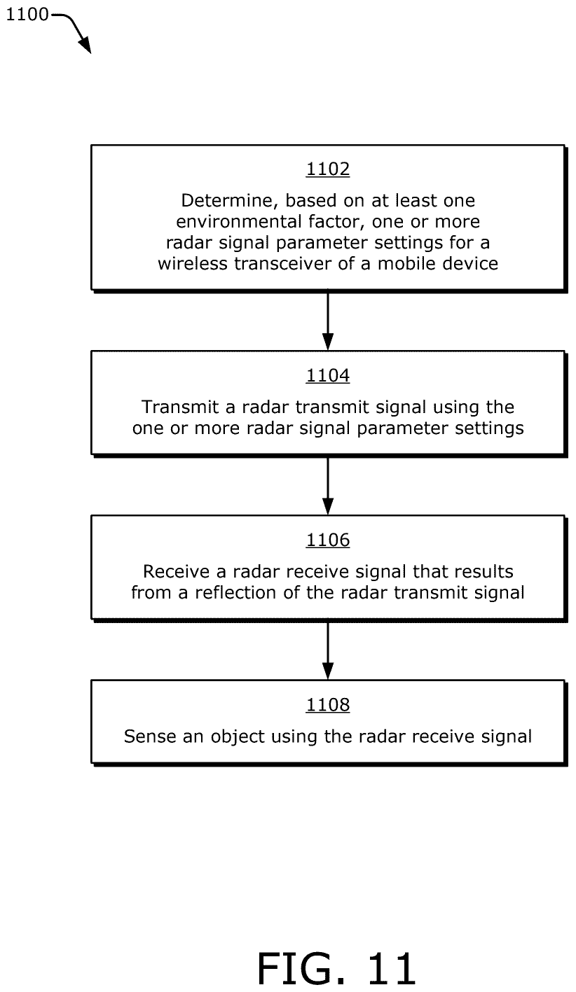

FIG. 11 is a flow diagram illustrating an example process 1100 for sensing objects using radar signal parameter settings that are configured based on at least one environmental factor. The process 1100 includes four blocks 1102-1108 that specify operations that can be performed for a method. However, operations are not necessarily limited to the order shown in the figures or described herein, for the operations may be implemented in alternative orders or in fully or partially overlapping manners. Also, more, fewer, and/or different operations may be implemented to perform a respective process or an alternative process.

In example implementations, operations represented by the illustrated blocks of each process may be performed by an electronic device, such as the computing device 102 of FIG. 1 (e.g., a mobile device, such as a cell phone). More specifically, the operations of the respective processes may be at least partially performed, for instance, by a radar-signal parameter-setting determination logic 128 and a radar system 408. The description of this flow diagram references other figures by way of example only.

At block 1102, based on at least one environmental factor, one or more radar signal parameter settings are determined for a wireless transceiver of a mobile device. For example, radar-signal parameter-setting determination logic 128 can determine, based on at least one environmental factor 410, one or more radar signal parameter settings for radar signal parameters 400-2 of a wireless transceiver 120 of a mobile device, which is an example of a computing device 102. For instance, based on an expected distance or speed of objects being targeted for sensing, the logic may determine one or more signal-related radar signal parameters 420 or one or more radar-related radar signal parameters 430.

At block 1104, a radar transmit signal is transmitted using the one or more radar signal parameter settings. For example, a radar system 408 can transmit a radar transmit signal 208 using the one or more radar signal parameter settings of the radar signal parameters 400-2. In some cases, the radar system 408 may transmit the radar transmit signal 208 with a transmit power setting or a frequency bandwidth setting determined from a multi-dimensional matrix that maps radar applications to radar signal parameter settings.

At block 1106, a radar receive signal that results from a reflection of the radar transmit signal is received. For example, the radar system 408 can receive a radar receive signal 210 that results from a reflection of the radar transmit signal 208. Thus, a receiver 504 may process a radar receive signal 210 having a reflected signal 216 to produce a receive signal 526 having been sampled by an ADC 520 according to a beat frequency (f_{B}) that is established, at least partially, by the radar-signal parameter-setting determination logic 128.

At block 1108, an object is sensed using the radar receive signal. For example, an object sensing unit 124 can sense an object 206 using the radar receive signal 210. Here, the object sensing unit 124 may sense the presence of the object 206, a distance or direction to the object 206, a speed of the object 206, and so forth. By using the settings for the radar signal parameters 400-2 as determined by the radar-signal parameter-setting determination logic 128, power efficiency and processing efficiency can be increased.

This section describes some aspects of example implementations and/or example configurations related to the apparatuses and/or processes presented above.

Example aspect 1: An apparatus comprising:
a wireless transceiver for a mobile device, the wireless transceiver configured to be connected to one or more antennas and configured to:
   determine one or more radar signal parameter settings based on at least one environmental factor;
   transmit a radar transmit signal using the one or more radar signal parameter settings;
   receive a radar receive signal that results from a reflection of the radar transmit signal; and sense an object using the radar receive signal.

Example aspect 2: The apparatus of example aspect 1, wherein the wireless transceiver is configured to:
ascertain the at least one environmental factor, the at least one environmental factor related to at least one of the mobile device or a user of the mobile device.

Example aspect 3: The apparatus of example aspect 2, wherein the wireless transceiver is configured to:
ascertain the at least one environmental factor based on at least one ambient condition.

Example aspect 4: The apparatus of example aspect 3, wherein the wireless transceiver is configured to:
determine the at least one ambient condition, the at least one ambient condition comprising at least one of a time, a weather condition, or a location of the mobile device.

Example aspect 5: The apparatus of any one of example aspects 2-4, wherein the wireless transceiver is configured to:
ascertain the at least one environmental factor based on at least one current activity.

Example aspect 6: The apparatus of example aspect 5, wherein the wireless transceiver is configured to:
determine the at least one current activity based on at least one of a calendar event or a movement of the mobile device.

Example aspect 7: The apparatus of any one of example aspects 2-6, wherein the wireless transceiver is configured to:
ascertain the at least one environmental factor based on at least one user input.

Example aspect 8: The apparatus of example aspect 7, wherein the wireless transceiver is configured to:
accept an indication of the at least one user input via at least one processor.

Example aspect 9: The apparatus of example aspect 7 or 8, further comprising:
a display screen; and
at least one processor coupled to the display screen, the at least one processor configured to:
   present a user interface on the display screen, the user interface including multiple applications related to sensing one or more objects using radar signaling; and
   detect the at least one user input responsive to the user interface being presented, the at least one user input corresponding to a selected application of the multiple applications.

Example aspect 10: The apparatus of example aspect 9, wherein the selected application of the multiple applications corresponds to gesture detection.

Example aspect 11: The apparatus of example aspect 9 or 10, wherein each application of the multiple applications respectively corresponds to an object range of multiple object ranges.

Example aspect 12: The apparatus of example aspect 11, wherein:
each application of the multiple applications respectively corresponds to a collection of radar signal parameter settings of multiple collections of radar signal parameter settings; and
each respective collection of radar signal parameter settings corresponds to:
   a far-range object;
   a mid-range object; or
   a near-range object.

Example aspect 13: The apparatus of any one of the preceding example aspects, wherein:
the at least one environmental factor comprises multiple environmental factors;
the one or more radar signal parameter settings comprise multiple radar signal parameter settings;
the wireless transceiver comprises a modem; and
the modem is configured to apply the multiple environmental factors to a multi-dimensional matrix to determine the multiple radar signal parameter settings.

Example aspect 14: The apparatus of any one of the preceding example aspects, wherein the wireless transceiver comprises:
a radar signaling path comprising a power amplifier and a low-noise amplifier, the radar signaling path corresponding to a first frequency range; and
a shared signaling path comprising multiple power amplifiers and multiple low-noise amplifiers, the shared signaling path configured to be coupled to an antenna array and corresponding to a second frequency range that is different from the first frequency range.

Example aspect 15: The apparatus of example aspect 14, wherein:
the first frequency range is higher than the second frequency range; and
the shared signaling path is configured to transceive radar signals and wireless communication signals.

Example aspect 16: The apparatus of example aspect 14 or 15, wherein:
the wireless transceiver comprises a frequency-varying local oscillator configured to produce a frequency-varying local-oscillator signal;
the radar signaling path is configured to transmit first radar transmit signals in the first frequency range based on the frequency-varying local-oscillator signal; and
the shared signaling path is configured to transmit second radar transmit signals in the second frequency range based on the frequency-varying local-oscillator signal.

Example aspect 17: The apparatus of example aspect 16, wherein:
the radar signaling path is configured to inject the frequency-varying local-oscillator signal into the shared signaling path by bypassing one or more phase shifters that precede, along a signal propagation pathway of the shared signaling path, a power amplifier of the multiple power amplifiers.

Example aspect 18: The apparatus of any one of example aspects 14-17, wherein:
the multiple power amplifiers and the multiple low-noise amplifiers of the shared signaling path comprise multiple pairs of amplifiers, each pair of amplifiers of the multiple pairs of amplifiers comprising a power amplifier of the multiple power amplifiers and a low-noise amplifier of the multiple low-noise amplifiers, each respective pair of amplifiers of the multiple pairs of amplifiers configured to be coupled to a respective antenna element of the antenna array;
the shared signaling path is configured to transmit radar transmit signals using a power amplifier of a first pair of amplifiers of the multiple pairs of amplifiers; and
the shared signaling path is configured to receive radar receive signals using a low-noise amplifier of a second pair of amplifiers of the multiple pairs of amplifiers.

Example aspect 19: The apparatus of example aspect 18, wherein:
a third pair of amplifiers of the multiple pairs of amplifiers is physically disposed between the first pair of amplifiers of the multiple pairs of amplifiers and the second pair of amplifiers of the multiple pairs of amplifiers.

Example aspect 20: The apparatus of any one of example aspects 14-19, wherein:
the radar signaling path is coupled to the shared signaling path at a node that is coupled between a phase shifter of the shared signaling path and a power amplifier of the multiple power amplifiers of the shared signaling path.

Example aspect 21: The apparatus of example aspect 20, wherein:
the shared signaling path comprises a transmission pathway;
the transmission pathway comprises the phase shifter, the node, and the power amplifier of the multiple power amplifiers of the shared signaling path; and the transmission pathway lacks another phase shifter between the node and an input of the power amplifier of the multiple power amplifiers of the shared signaling path.

Example aspect 22: The apparatus of example aspect 20 or 21, wherein:
the shared signaling path comprises a transmission pathway;
the transmission pathway comprises the phase shifter, the node, the power amplifier of the multiple power amplifiers of the shared signaling path, and an antenna port for an antenna element of the antenna array; and
the transmission pathway lacks another power amplifier between the power amplifier and the antenna port of the transmission pathway.

Example aspect 23: The apparatus of any one of the preceding example aspects, wherein the wireless transceiver is configured to:
determine the one or more radar signal parameter settings by determining at least one of a frequency range, a frequency bandwidth, or a transmit power based on the at least one environmental factor.

Example aspect 24: The apparatus of any one of the preceding example aspects, wherein the wireless transceiver is configured to:
determine the one or more radar signal parameter settings by determining a pulse repetition interval based on the at least one environmental factor.

Example aspect 25: The apparatus of any one of the preceding example aspects, wherein the wireless transceiver is configured to:
determine the one or more radar signal parameter settings by determining at least one of a dwell time or a number of chirps per dwell time based on the at least one environmental factor.

Example aspect 26: The apparatus of any one of the preceding example aspects, wherein the wireless transceiver is configured to:
determine the one or more radar signal parameter settings by determining, based on the at least one environmental factor, a frame period indicative of a period at which a dwell time is repeated.

Example aspect 27: The apparatus of any one of the preceding example aspects, wherein the wireless transceiver is configured to:
increase a transmit power for the radar transmit signal as a targeted range for object sensing increases; and
decrease the transmit power for the radar transmit signal as the targeted range for object sensing decreases.

Example aspect 28: The apparatus of any one of the preceding example aspects, wherein the wireless transceiver is configured to decrease a radar bandwidth as a targeted range for object sensing increases.

Example aspect 29: An apparatus comprising:
means for determining one or more radar signal parameter settings based on at least one environmental factor;
means for transmitting a radar transmit signal using the one or more radar signal parameter settings;
means for receiving a radar receive signal that results from a reflection of the radar transmit signal; and
means for sensing an object using the radar receive signal.

Example aspect 30: A method for sensing objects using configured radar signal parameter settings, the method comprising:
determining, based on at least one environmental factor, one or more radar signal parameter settings for a wireless transceiver of a mobile device;
transmitting a radar transmit signal using the one or more radar signal parameter settings;
receiving a radar receive signal that results from a reflection of the radar transmit signal; and
sensing an object using the radar receive signal.

As used herein, the terms “couple,” “coupled,” or “coupling” refer to a relationship between two or more components that are in operative communication with each other to implement some feature or realize some capability that is described herein. The coupling can be realized using, for instance, a physical line, such as a metal trace or wire, or an electromagnetic coupling, such as with a transformer. A coupling can include a direct coupling or an indirect coupling. A direct coupling refers to connecting discrete circuit elements via a same node without an intervening element. An indirect coupling refers to connecting discrete circuit elements via one or more other devices or other discrete circuit elements, including two or more different nodes.

The term “node” (e.g., including a “first node” or a “input node”) represents at least a point of electrical connection between two or more components (e.g., circuit elements). Although at times a node may be visually depicted in a drawing as a single point, the node can represent a connection portion of a physical circuit or network that has approximately a same voltage potential at or along the connection portion between two or more components. In other words, a node can represent at least one of multiple points along a conducting medium (e.g., a wire or trace) that exists between electrically connected components. Similarly, a “terminal” or “port” may represent one or more points with at least approximately a same voltage potential relative to an input or output of a component (e.g., a mixer).

The terms “first,” “second,” “third,” and other numeric-related indicators are used herein to identify or distinguish similar or analogous items from one another within a given context—such as a particular implementation, a single drawing figure, a given component, or a claim. Thus, a first item in one context may differ from a first item in another context. For example, an item identified as a “first frequency” in one context may be identified as a “second frequency” in another context. Similarly, a “second radar signal parameter” or a “first radar application” in one claim may be recited as a “third radar signal parameter” or a “second radar application,” respectively, in a different claim (e.g., in separate claim sets). An analogous interpretation applies to differential-related terms such as a “plus signal component” and a “minus signal component” and to real-imaginary signal parts such as “real (or in-phase) signal data” and “imaginary (or quadrature) signal data. ” Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Further, items represented in the accompanying figures and terms discussed herein may be indicative of one or more items or terms, and thus reference may be made interchangeably to single or plural forms of the items and terms in this written description.

Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed. Rather, the specific features and methods are disclosed as example implementations for a reconfigurable multimode radar.

What is claimed is:

1. An apparatus comprising:
a wireless transceiver for a mobile device, the wireless transceiver configured to be connected to one or more antennas and configured to:
determine one or more radar signal parameter settings based on at least one environmental factor;
transmit a radar transmit signal using the one or more radar signal parameter settings;
receive a radar receive signal that results from a reflection of the radar transmit signal; and
sense an object using the radar receive signal.

2. The apparatus of claim 1, wherein the wireless transceiver is configured to:
ascertain the at least one environmental factor, the at least one environmental factor related to at least one of the mobile device or a user of the mobile device.

3. The apparatus of claim 2, wherein the wireless transceiver is configured to:
ascertain the at least one environmental factor based on at least one ambient condition.

4. The apparatus of claim 2, wherein the wireless transceiver is configured to:
ascertain the at least one environmental factor based on at least one current activity.

5. The apparatus of claim 2, wherein the wireless transceiver is configured to:
ascertain the at least one environmental factor based on at least one user input.

6. The apparatus of claim 5, further comprising:
a display screen; and
at least one processor coupled to the display screen, the at least one processor configured to:
present a user interface on the display screen, the user interface including multiple applications related to sensing one or more objects using radar signaling; and
detect the at least one user input responsive to the user interface being presented, the at least one user input corresponding to a selected application of the multiple applications.

7. The apparatus of claim 6, wherein the selected application of the multiple applications corresponds to gesture detection.

8. The apparatus of claim 6, wherein each application of the multiple applications respectively corresponds to an object range of multiple object ranges.

9. The apparatus of claim 1, wherein:
the at least one environmental factor comprises multiple environmental factors;
the one or more radar signal parameter settings comprise multiple radar signal parameter settings;
the wireless transceiver comprises a modem; and
the modem is configured to apply the multiple environmental factors to a multi-dimensional matrix to determine the multiple radar signal parameter settings.

10. The apparatus of claim 1, wherein the wireless transceiver comprises:
a radar signaling path comprising a power amplifier and a low-noise amplifier, the radar signaling path corresponding to a first frequency range; and
a shared signaling path comprising multiple power amplifiers and multiple low-noise amplifiers, the shared signaling path configured to be coupled to an antenna array and corresponding to a second frequency range that is different from the first frequency range.

11. The apparatus of claim 10, wherein:
the first frequency range is higher than the second frequency range; and
the shared signaling path is configured to transceive radar signals and wireless communication signals.

12. The apparatus of claim 10, wherein:
the wireless transceiver comprises a frequency-varying local oscillator configured to produce a frequency-varying local-oscillator signal;
the radar signaling path is configured to transmit first radar transmit signals in the first frequency range based on the frequency-varying local-oscillator signal; and
the shared signaling path is configured to transmit second radar transmit signals in the second frequency range based on the frequency-varying local-oscillator signal.

13. The apparatus of claim 10, wherein:
the multiple power amplifiers and the multiple low-noise amplifiers of the shared signaling path comprise multiple pairs of amplifiers, each pair of amplifiers of the multiple pairs of amplifiers comprising a power amplifier of the multiple power amplifiers and a low-noise amplifier of the multiple low-noise amplifiers, each respective pair of amplifiers of the multiple pairs of amplifiers configured to be coupled to a respective antenna element of the antenna array;
the shared signaling path is configured to transmit radar transmit signals using a power amplifier of a first pair of amplifiers of the multiple pairs of amplifiers; and
the shared signaling path is configured to receive radar receive signals using a low-noise amplifier of a second pair of amplifiers of the multiple pairs of amplifiers.

14. The apparatus of claim 10, wherein:
the radar signaling path is coupled to the shared signaling path at a node that is coupled between a phase shifter of the shared signaling path and a power amplifier of the multiple power amplifiers of the shared signaling path.

15. The apparatus of claim 1, wherein the wireless transceiver is configured to:
determine the one or more radar signal parameter settings by determining at least one of a frequency range, a frequency bandwidth, or a transmit power based on the at least one environmental factor.

16. The apparatus of claim 1, wherein the wireless transceiver is configured to at least one of:
determine the one or more radar signal parameter settings by determining a pulse repetition interval based on the at least one environmental factor;
determine the one or more radar signal parameter settings by determining at least one of a dwell time or a number of chirps per dwell time based on the at least one environmental factor; or
determine the one or more radar signal parameter settings by determining, based on the at least one environmental factor, a frame period indicative of a period at which a dwell time is repeated.

17. The apparatus of claim 1, wherein the wireless transceiver is configured to:
increase a transmit power for the radar transmit signal as a targeted range for object sensing increases; and
decrease the transmit power for the radar transmit signal as the targeted range for object sensing decreases.

18. The apparatus of claim 1, wherein the wireless transceiver is configured to decrease a radar bandwidth as a targeted range for object sensing increases.

19. An apparatus comprising:
means for determining one or more radar signal parameter settings based on at least one environmental factor;
means for transmitting a radar transmit signal using the one or more radar signal parameter settings;
means for receiving a radar receive signal that results from a reflection of the radar transmit signal; and
means for sensing an object using the radar receive signal.

20. A method for sensing objects using configured radar signal parameter settings, the method comprising:
determining, based on at least one environmental factor, one or more radar signal parameter settings for a wireless transceiver of a mobile device;
transmitting a radar transmit signal using the one or more radar signal parameter settings;
receiving a radar receive signal that results from a reflection of the radar transmit signal; and
sensing an object using the radar receive signal.
